(19) United States
(12) Patent Application Publication
(10) Pub. No.: US 2008/0007567 A1
(43) Pub. Date: Jan. 10, 2008

(54) System and Method for Generating Advertising in 2D or 3D Frames and Scenes

(76) Inventors: Paul Clatworthy, Los Gatos, CA (US); Sally Walsh, Los Gatos, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/761,927

(22) Filed: Jun. 12, 2007

Related U.S. Application Data
(63) Continuation-in-part of application No. 11/622,341, filed on Jan. 11, 2007.
(63) Continuation-in-part of application No. 11/432,204, filed on May 10, 2006.
(60) Provisional application No. 60/891,701, filed on Feb. 26, 2007.
(60) Provisional application No. 60/794,213, filed on Apr. 21, 2006.
(60) Provisional application No. 60/597,739, filed on Dec. 18, 2005.
(60) Provisional application No. 60/794,213, filed on Apr. 21, 2006.

(51) Int. Cl. G09G 5/00

(52) U.S. Cl. 345/619

(57) ABSTRACT

A system comprises a frame array memory for storing frames of a scene, each frame including a set of objects; an advertisement library for storing advertisements; an advertisement selection engine coupled to the advertisement library operative to enable selecting a number of the advertisements from the advertisement library; and an advertisement manager coupled to the advertisement selection engine and to the frame array memory operative to incorporate selected advertisement into the scene.

### PRIORITY CLAIM

This application claims benefit of U.S. provisional application serial number 60/891,701 filed on Feb. 26, 2007; is a continuation-in-part of U.S. patent application Ser. No. 11,622,341 filed on Jan. 11, 2007 (‘the '341 application); and is a continuation-in-part of U.S. patent application Ser. No. 11,432,204 filed on May 10, 2006 (the '204 application). Both the '341 application and the '204 application claim benefit of U.S. provisional patent application Ser. No. 60/597,739 filed on Dec. 18, 2005; and of U.S. provisional patent application Ser. No. 60/794,213 filed on Apr. 21, 2006. These applications are all hereby incorporated by reference.

### TECHNICAL FIELD

This invention relates generally to computers, and more particularly to a system and method for generating advertising in 2D or 3D frames and/or scenes.

### BACKGROUND

In film and other creative industries, storyboards are a series of drawings used in the pre-visualization of a live action or an animated film (including movies, television, commercials, animations, games, technical training projects, etc.). Storyboards provide a visual representation of the composition and spatial relationship of objects, e.g., background, characters, props, etc., to each other within a shot or scene.

Cinematic images for a live action film were traditionally generated by a narrative scene acted out by actors portraying characters from a screenplay. In the case of an animated film, the settings and characters making up the cinematic images were drawn by an artist. More recently, computer two-dimensional (2D) and three-dimensional (3D) animation tools have replaced hand drawings. With the advent of computer software such as Storyboard Quick and Storyboard Artist by PowerProduction Software, a person with little to no drawing skills is now be capable of generating computer-rendered storyboards for a variety of visual projects.

Generally, each storyboard frame represents a shot-size segment of a film. In the film industry, a “shot” is defined as a single, uninterrupted roll of the camera. In the film industry, multiple shots are edited together to form a “scene” or “sequence.” A “scene” or “sequence” is usually defined as a segment of a screenplay acted out in a single location. A completed screenplay or film is made up of series of scenes, and therefore many shots.

By skillful use of shot size, element placement and cinematic composition, storyboards can convey a story in a sequential manner and help to enhance emotional and other non-verbal information cinematically. Typically, a director, auteur and/or cinematographer controls the content and flow of a visual plot as defined by the script or screenplay. To facilitate telling the story and bend an audience's emotional response, the director, auteur and/or cinematographer may employ cinematic conventions such as:
Establishing shot: A Shot of the general environment—typically used at a new location to give an audience a sense of time and locality (e.g., the city at night).
Long shot: A shot of the more proximate general environment—typically used to show a scene from a distance but not as far as an establishing shot (e.g., a basketball court).
Close-ups: A shot of a particular item—typically used to show tension by focusing on a character's reaction (e.g., a person's face and upper torso).
Extreme close-ups: A shot of a single element of a larger item (e.g., a facial feature of a face).
Medium shot: A shot between the close up and a long shot—for a character, typically used to show a waist-high “single” covering one character, but can be used to show a group shot (e.g., several characters of a group), a two-shot (e.g., a shot with two people in it), an over-the-shoulder shot (e.g., a shot with two people, one facing backward, one facing forward) or another shot that frames the image and appears “normal” to the human eye.

To show object movement or camera movement in a shot or scene, storyboard frames often use arrows. Alternatively, animatic storyboards may be used. Animatic storyboards include conventional storyboard frames that are presented sequentially to emulate motion. Animatic storyboards may use in-frame movement and/or between-frame transitions and may include sound and music.

Generating a storyboard frame is a time-consuming process of designing, drawing or selecting images, positioning object into a frame, sizing objects individually, etc. The quality of each resulting storyboard frame depends on the user's drawing skills, knowledge, experience and ability to make creative interpretative decisions about a script. A system and method that assists with and/or automates the generation of storyboards are needed. Also, because a 3D representation of a storyboard frame affords greater flexibility and control, especially when preparing for adding animation and motion elements than a 2D storyboard, a system and method that assist and/or automate the generation of 3D scenes are needed. Further, to add flexibility and revenue generation, a system and method that enable and possibly automate the addition of advertisements in 2D or 3D storyboards or in 3D scenes are needed.

### SUMMARY

Per a first embodiment, the present invention provides a system comprising a frame array memory for storing frames of a scene, each frame including a set of objects; an advertisement library for storing advertisements; an advertisement selection engine coupled to the advertisement library operative to enable selecting a number of the advertisements from the advertisement library; and an advertisement manager coupled to the advertisement selection engine and to the frame array memory operative to incorporate selected advertisements into the scene. One of the advertisements may include one of a replacement object, a new object, a replacement skin for one of the set of objects, a new skin for a new object, replacement text, new text, a billboard, character business for a character object in the set of objects, a cutaway to one of the objects, or a cutaway to a new object. Each of the objects of the set of objects may include object metadata defining corresponding capabilities. The advertisement selection engine may use the object metadata to determine available advertisements. Each of the advertisements may include advertisement metadata, the advertisement metadata defining attributes of the advertisements. The advertisement selection engine may use a prioritization algorithm and the advertisement metadata to prioritize at least a portion of the advertisements. The advertisement selection engine may generate a prioritized list of advertisements and may enable a user to select the number of advertisements from the prioritized list of advertisements. The advertisement metadata may include bid amount data, relevance metadata, appropriate metadata and/or advertisement type. The advertisement selection engine may enable a user to select the number of advertisements. The system may further comprise an advertisement level configuration engine coupled to the advertisement selection engine operative to determine a level indicator for determining the number of advertisements. The system may further comprise an advertisement library manager coupled to the advertisement library operative to enable an advertiser to input the advertisements into the advertisement library. The advertisement manager may incorporate the selected advertisements into one of the frames of the scene, and/or into at least one new frame and adds the at least one new frame to the scene.

In accordance with another embodiment, the present invention provides a method comprising storing frames of a scene, each frame including a set of objects; storing advertisements and advertisement metadata; enabling selection of a number of the advertisements; and incorporating selected advertisements into the scene. One of the advertisements may include one of a replacement object, a new object, a replacement skin for one of the set of objects, a new skin for a new object, replacement text, new text, a billboard, character business for a character object in the set of objects, a cutaway to one of the objects, or a cutaway to a new object. Each of the objects of the set of objects may include object metadata defining corresponding capabilities. The method may further comprise using the object metadata to determine available advertisements. Each of the advertisements may include advertisement metadata, the advertisement metadata defining attributes of the advertisements. The method may further comprise using a prioritization algorithm and the advertisement metadata to prioritize at least a portion of the advertisements. The method may further comprise generating a prioritized list of advertisements; and enabling a user to select the number of advertisements from the prioritized list of advertisements. The advertisements metadata may include bid amount data, relevance metadata, appropriate metadata, and/or advertisement type. The method may further comprise enabling a user to select the number of advertisements. The method may further comprise establishing a level indicator for determining the number of advertisements. The method may further comprise enabling an advertiser to input advertisements. The step of incorporating may include incorporating the selected advertisements into one of the frames of the scene, and/or incorporating the selected advertisements into at least one new frame and adding the at least one new frame to the scene.

### BRIEF DESCRIPTION OF THE DRAWINGS

FIG. 1A is a block diagram of a computer having a cinematic frame creation system, in accordance with an embodiment of the present invention.

FIG. 2 is a block diagram of a computer network having a cinematic frame creation system, in accordance with an embodiment of the present invention.

FIG. 3 is a block diagram illustrating details of the cinematic frame creation system, in accordance with an embodiment of the present invention.

FIG. 4 is a block diagram illustrating details of the segment analysis module, in accordance with an embodiment of the present invention.

FIG. 5 is a flowchart illustrating a method of converting text to storyboard frames, in accordance with an embodiment of the present invention.

FIG. 6 is a flowchart illustrating a method of searching story scope data and generating frame array memory, in accordance with an embodiment of the present invention.

FIG. 7 illustrates an example script text file.

FIG. 8 illustrates an example formatted script text file.

FIG. 9 illustrates an example of an assembled storyboard frame generated by the cinematic frame creation system, in accordance with an embodiment of the present invention.

FIG. 10 is an example series of frames generated by the cinematic frame creation system using a custom database of character and background objects, in accordance with an embodiment of the present invention.

FIG. 11 is a block diagram illustrating details of a 2D-to-3D frame conversion system, in accordance with an embodiment of the present invention.

FIG. 12 is a block diagram illustrating details of the dictionary/libraries, in accordance with an embodiment of the present invention.

FIG. 13A is a block diagram illustrating details of a 2D frame array memory, in accordance with an embodiment of the present invention.

FIG. 13B is a block diagram illustrating details of a 3D frame array memory, in accordance with an embodiment of the present invention.

FIG. 14 illustrates an example 2D storyboard, in accordance with an embodiment of the present invention.

FIG. 15 illustrates an example 3D wireframe generated from the 2D storyboard of FIG. 14, in accordance with an embodiment of the present invention.

FIG. 16A illustrates an example 3D scene rendered from the 3D scene of FIG. 15, in accordance with an embodiment of the present invention.

FIG. 16B illustrates an example 3D scene that may be used as an end-frame of an animation sequence, in accordance with an embodiment of the present invention.

FIG. 17 is a flowchart illustrating a method of converting a 2D storyboard frame to a 3D scene, in accordance with an embodiment of the present invention.

FIG. 18 is a block diagram illustrating a 3D advertisement system, in accordance with an embodiment of the present invention.

FIG. 19 is a block diagram illustrating an example advertisement library, in accordance with an embodiment of the present invention.

FIG. 19B is a block diagram illustrating an advertisement library manager, in accordance with an embodiment of the present invention.

FIG. 20 is a flowchart illustrating a method of adding advertisements to a 3D frame or scene, in accordance with an embodiment of the present invention.

FIG. 21 is a flowchart illustrating a method of prioritizing available advertisements, in accordance with an embodiment of the present invention.

FIG. 22 is a flowchart illustrating a method of incorporating advertisement into a frame or scene, in accordance with an embodiment of the present invention.

### DETAILED DESCRIPTION

The following description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

An embodiment of the present invention enables automatic translation of natural language, narrative text (e.g., script, a chat-room dialogue, etc.) into a series of sequential storyboard frames and/or storyboard shots (e.g., animatics) by means of a computer program. One embodiment provides a computer-assisted system, method and/or computer program product for translating natural language text into a series of storyboard frames or shots that portray spatial relationships between characters, locations, props, etc. based on proxemic, cinematic, narrative structures and conventions. The storyboard frames may combine digital still images (including 3D images) and/or digital motion picture images of backgrounds, characters, props, etc. from a predefined and customizable library into layered cinematic compositions. Each object, e.g., background, character, prop or other object, can be moved and otherwise independently customized. The resulting storyboard frames can be rendered as a series of digital still images or as a digital motion picture with sound, conveying context, emotion and storyline of the entered and/or imported text. The text can also be translated to speech sound files and added to the motion picture with the length of the sounds used to determine the length of time a particular shot is displayed. It will be appreciated that a storyboard shot may include one or more storyboard frames. Thus, some embodiments that generate storyboard shots may include the generation of storyboard frames. Similarly, a scene may include one or more storyboard shots. Thus, some embodiments that generate scenes may include the generation of storyboard shots, which includes the generation of storyboard frames.

One embodiment may assist with the automation of visual literacy and storytelling. Another embodiment may save time and energy for those beginning the narrative story pre-visualizing and visualizing process. Yet another embodiment may enable the creation of storyboard frames and/or shots, which can be further customized. Still another embodiment may assist teachers trying to teach students the language of cinema. Another embodiment may simulate a director's process of analyzing and converting a screenplay or other narrative text into various frames and/or shots (including movie clips and/or movie clips with advertising).

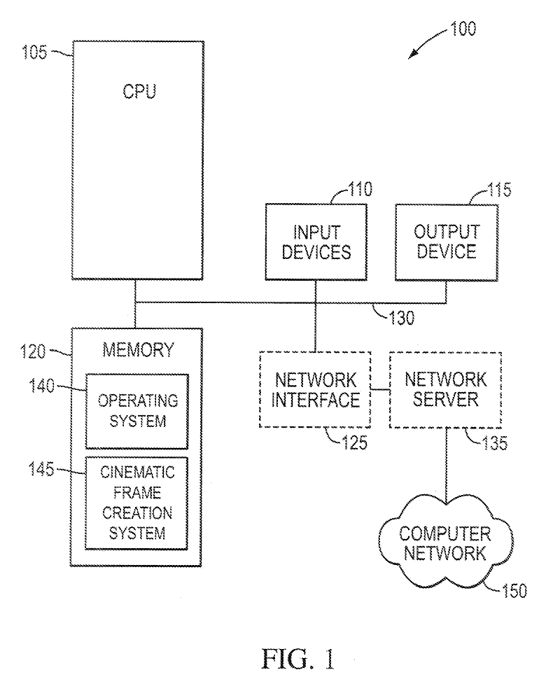

FIG. 1 is a block diagram of a computer 100 having a cinematic frame creation system 145, in accordance with an embodiment of the present invention. As shown, the cinematic frame creation system 145 may be a stand-alone application. Computer 100 includes a central processing unit (CPU) 105 (such as an Intel Pentium® microprocessor or a Motorola Power PC® microprocessor), an input device 110 (such as a keyboard, mouse, scanner, disk drive, electronic fax, USB port, etc.), an output device 115 (such as a display, printer, fax, etc.), a memory 120, and a network interface 125, each coupled to a computer bus 130. The network interface 125 may be coupled to a network server 135, which provides access to a computer network 150 such as the wide-area network commonly referred to as the Internet. Memory 120 stores an operating system 140 (such as the Microsoft Windows XP, Linux, the IBM OS/2 operating system, the MAC OS, or UNIX operating system( and the cinematic frame creation system 145. The cinematic frame creation system 145 may be written using JAVA, XML, C++ and/or other computer languages, possibly using object-oriented programming methodology. It will be appreciated that the term “memory” herein is intended to cover all data storage media whether permanent or temporary.

The cinematic frame creation system 145 may receive input text (e.g., script, descriptive text, a book, and/or written dialogue) from the input device 110, from the computer network 150, etc. For example, the cinematic frame creation system 145 may receive a text file downloaded from a disk, typed into the keyboard, downloaded from the computer network 150, received from an instant messaging session, etc. The text file can be imported or typed into designated text areas. In one embodiment, a text file or a screenplay-formatted file such as .FCF, .TAG or .TXT can be imported into the system 145.

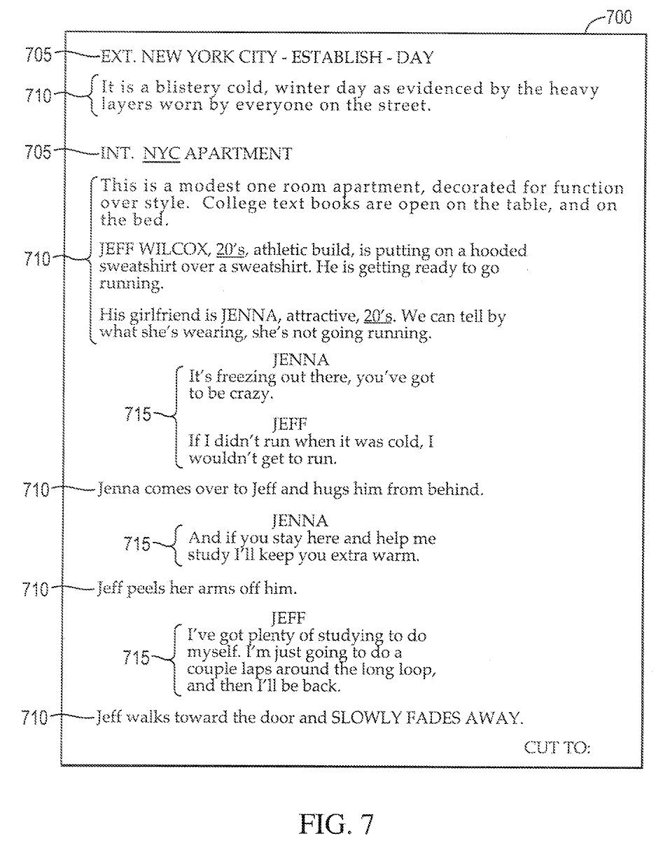

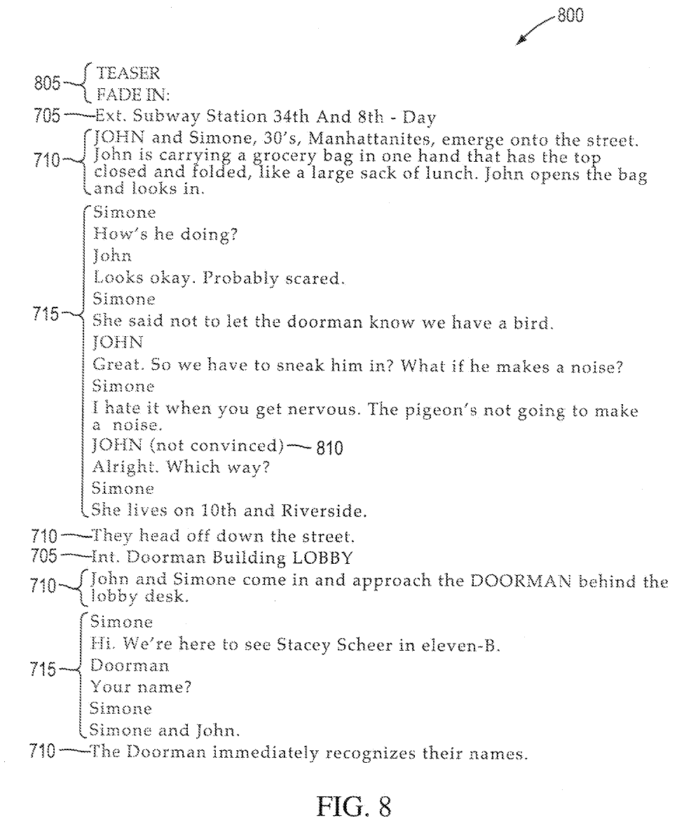

Examples texts that can be input into the cinematic frame creation system 145 are shown in FIGS. 7 and 8. FIG. 7 illustrates an example script-format text file 700. Script-format text file 700 includes slug lines 705, scene descriptions 710, and character dialogue 715. FIG. 8 illustrates another example script-formatted text file 800. Text file 800 includes scene introduction/conclusion text 805 (keywords to indicate a new scene is beginning or ending), slug lines 705, scene descriptions 710, character dialogue 715, and parentheticals 810. A slug line 05 is a cinematic tool indicating generally location and/or time. In a screenplay format, an example slug line is “INT, CITY HALL-DAY.” Introduction/conclusion text 805 includes commonly used keywords such as “FADE IN” to indicate the beginning of a new scene and/or commonly used keywords such as “FADE OUT” to indicate the ending of a scene. A scene description 710 is non-dialogue text describing character information, action information and/or other scene information. A parenthetical 810 is typically scene information offset by parentheses. It will be appreciated that scene descriptions 710 and parentheticals 810 are similar, except that scene descriptions 710 typically do not have a character identifier nearby and parentheticals 710 are typically bounded by parentheses.

The cinematic frame creation system 145 may translate received text into a series of storyboard frames and/or shots that represent the narrative structure and convey the story. The cinematic frame creation system 145 applies cinematic (visual storytelling) conventions to place, size and position elements into sequential frames. The series can be re-arranged, and specific frames can be deleted, added and edited. The series of rendered frames can be displayed on the output device 115, saved to a file in memory 120, printed to output device 115, exported to other formats (streaming video, QuickTime Movie or AV1 file), and/or exported to other devices such as another program or computer (e.g., for editing).

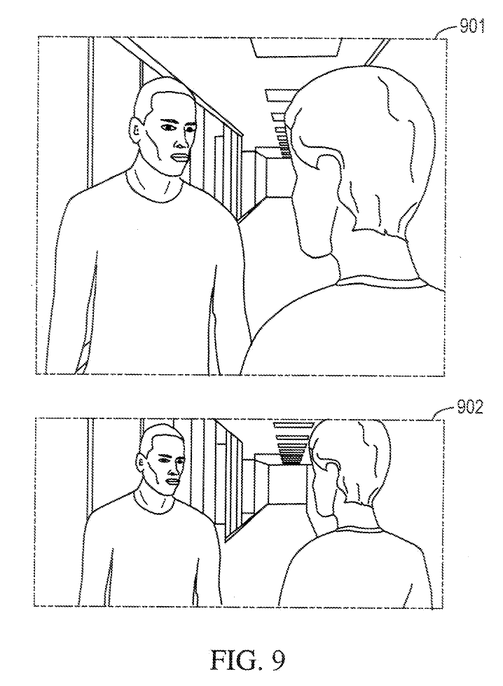

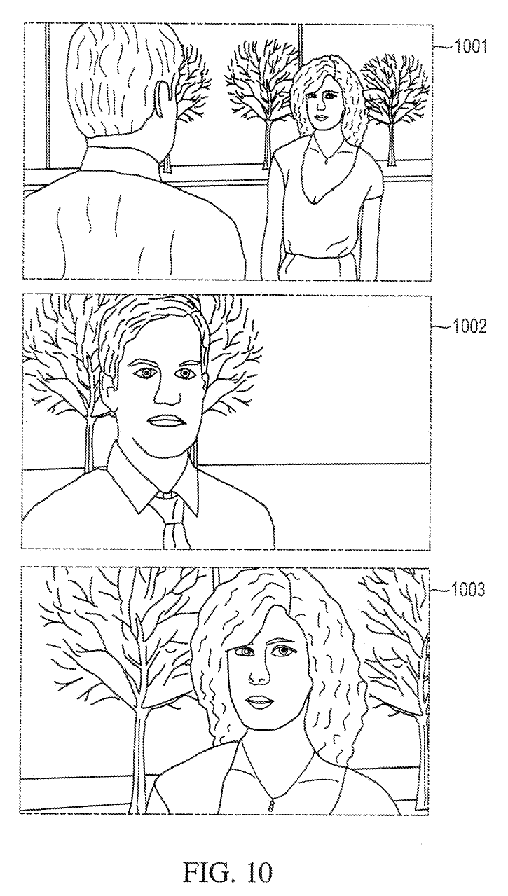

Examples of frames generated by the cinematic frame creation system 145 are shown in FIGS. 9 and 10. FIG. 9 illustrates two example storyboard frames generated by the cinematic frame creation system 145, in accordance with two embodiments of the present invention. The first frame 901 is a two-shot and an over-the-shoulder shot and was created for a Television aspect ratio. (1.33). The second frame 902 includes generally the same content (i.e., a two-shot and an over-the-shoulder shot of the same two characters in the same location) but object placement is adjusted for a wide-screen format. The second frame 902 has less headroom and a background wider than the first frame 901. In both frames 901 and 902, the characters are distributed in cinematically pleasing composition based on variety of cinematic conventions, e.g., headroom, ground space, horizon, edging, etc. FIG. 10 is an example series of three storyboard frames 1001, 1002, and 1003 generated by the cinematic frame creation system 145 using a custom database of character renderings and backgrounds, in accordance with an embodiment of the present invention.

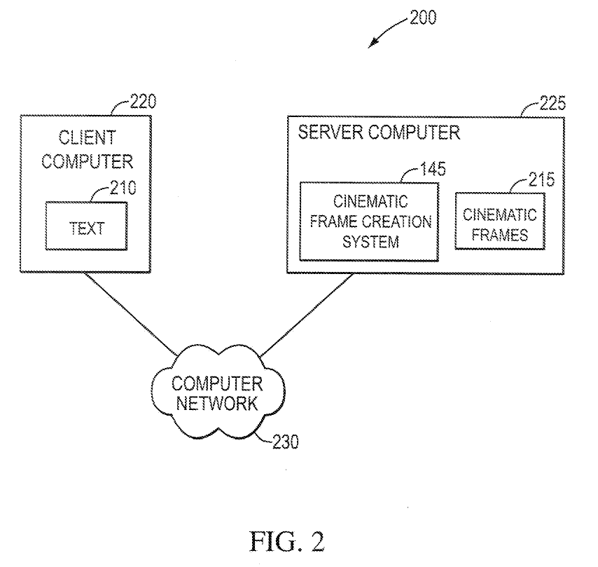

FIG. 2 is a block diagram of a computer network 200 having a cinematic frame creation system 145, in accordance with a distributed embodiment of the present invention. The computer network 200 includes a client computer 220 coupled via a computer network 230 to a server computer 225. As shown, the cinematic frame creation system 145 is located on the server computer 225, may receive text 210 from the client computer 220, and may generate the cinematic frames 215 which can be forwarded to the client computer 220. Other distributed environments are also possible.

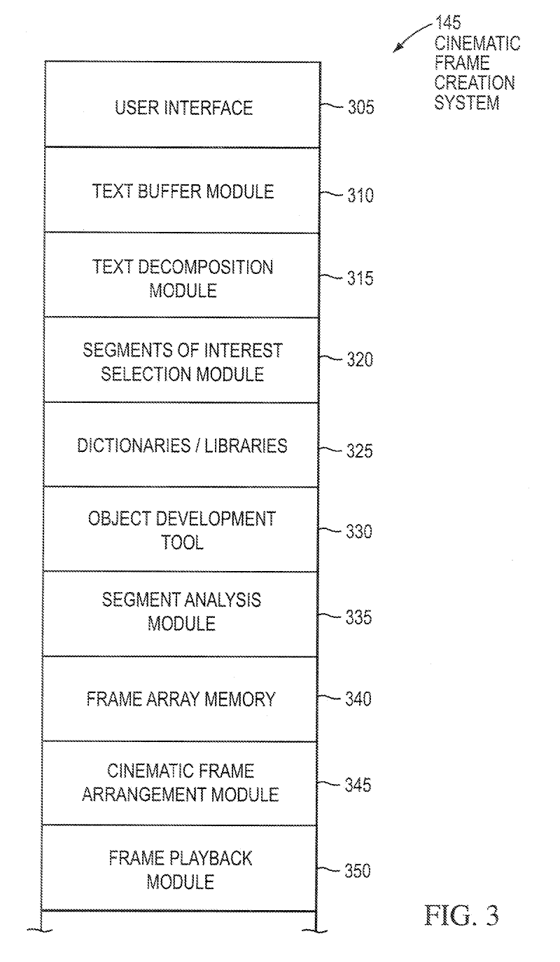

FIG. 3 is a block diagram illustrating details of the cinematic frame creation system 145, in accordance with an embodiment of the present invention. The cinematic frame creation system 145 includes a user interface 305, a text buffer module 310, a text decomposition module 315, a segments-of-interest selection module 320, dictionaries/libraries 325, an object development tool 330, a segment analysis module 335, frame array memory 340, a cinematic frame arrangement module 345, and a frame playback module 350.

The user interface 305 includes a user interface that enables user input of text user input and/or modifications of objects (character names and renderings, environment names and renderings, prop names and renderings, etc.), user modification of resulting frames, user selection of a frame size or aspect ratio (e.g., TV aspect, US Film, European Film, HDTV, Computer Screen, 16 mm, 3GPP and 3GPP2 mobile phone, etc.), etc.

The text buffer module 310 includes memory for storing text received for storyboard frame creation. The text buffer module 310 may include RAM, Flash memory, portable memory, permanent memory, disk storage, and/or the like. The text buffer module 310 includes hardware, software and/or firmware that enable retrieving text lines/segments/etc. for feeding to the other modules, e.g., to the segment analysis module 335.

The text decomposition module 315 includes hardware, software and/or firmware that enables automatic or assisted decomposition of text into a set of segments, e.g., single line portions, sentence size portions, shot-size portions, scene-size portions, etc. To conduct segmentation, the text decomposition module 315 may review character names, generic characters (e.g., Lady #1, Boy #2, etc.), slug lines, sentence counts, verbs, punctuation, keywords and/or other criteria. The text decomposition module 315 may search for changes of location, changes of scene information, changes of character names, etc. In one example, the text decomposition module 315 labels each segment by sequential numbers for case of identification.

Using script text 700 of FIG. 7 as an example, the text decomposition module 315 may decompose the script text 700 into a first segment including the slug line 705, a second segment including the first scale description 710, a third segment including the second slug line 705, a fourth segment including the first sentence of the first paragraph of the second scene description 710, etc. Each character name may be a single segment. Each statement made by each character may be a single segment. The text decomposition module 315 may decompose the text in various other ways.

The segments-of-interest selection module 320 includes hardware, software and/or firmware that enables selection of a sequence of segments of interest for storyboard frame creation. The user may select frames by selecting a set of segment numbers, whether sequential or not. The user may be given a range of numbers (from x to n: the number of segments found during the text decomposition) and location names, if available. The user may enter a sequential range of segment numbers of interest for the storyboard frames (and/or shots) he or she wants to create.

The dictionaries/libraries 325 include the character names, prop names, environmental names, generic character identifiers, and/or other object names and include their graphical renderings, e.g., avatar, object images, environment images, etc. For a character, object names may include descriptors like “Jeff,” “Jenna,” “John,” “Simone”, etc. For a prop, objects names may include descriptors like “ball,” “car,” “bat,” “toy,” etc. For a generic character identifier, object names may include descriptors like “Lady #1,” “Boy #2,” “Policeman #1,” etc. For an environment, environment names may include descriptors, like “in the park,” “at home,” “bus station,” “NYC,” etc. For a character name or generic character identifier, the graphical renderings may include a set of animated, 2D still, 3D, moving, standard or customized images, each image possibly showing the person in a different position or performing a different action (e.g., sitting, standing, bending, lying down, jumping, running, sleeping, etc.), from different angles, etc. For a prop, the graphical renderings may include a set of animated, 2D still, 3D, moving, standard or customized images, each image possibly showing the prop from a different angle, etc. For an environment, the graphical renderings may include a set of animated, 2D still, 3D, moving, standard or customized images. The set of environment images may include several possible locations at various times, with various amounts of lighting, illustrating various levels of detail, at various distances, etc.

In one embodiment, the dictionary 325 includes a list of possible object names (including proper names and/or generic names), each with a field for a link to a graphical rendering in the library 325, and the library 325 includes the graphical renderings. The associated graphical renderings may comprise generic images of men, generic images of women, generic images of props, generic environments, etc. Even though there may be thousands of names to identify a boy, the library 325 may contain a smaller number of graphical renderings for a boy. The fields in the dictionary 325 may be populated during segment analysis to link the objects (e.g., characters, environments, props, etc.) in the text to graphical renderings in the library 325.

In one embodiment, the dictionaries 325 may be XML lists of stored data. Their “meanings” may be defined by images or multiple image paths. The dictionaries 325 can grow by user input, customization or automatically.

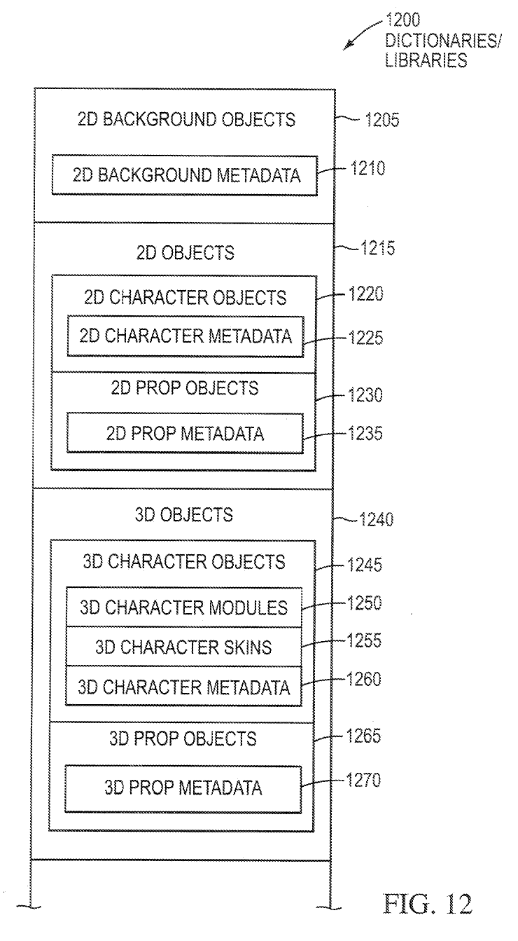

An example of the dictionaries/libraries 325 is shown in and described below with reference to FIG. 12.

The object development tool 330 includes hardware, software and/or firmware that enables a user to create and/or modify object names, graphical renderings, and the association of names with graphical renderings. A user may create an object name and an associated customized graphical renderings for each character, each environment, each prop, etc. The graphical renderings may be animated, digital photographs, blends of animation, 2D still, 3D, moving pictures and digital photographs, etc. The object development tool 330 may include drawing tools, photography tools, 3D rendering tools, etc.

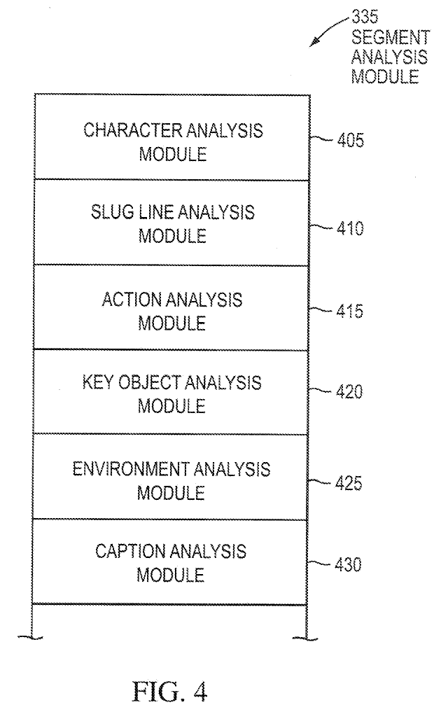

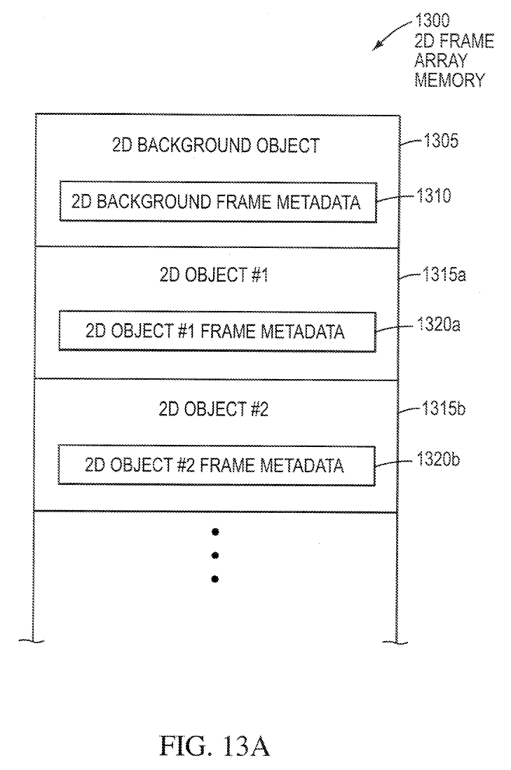

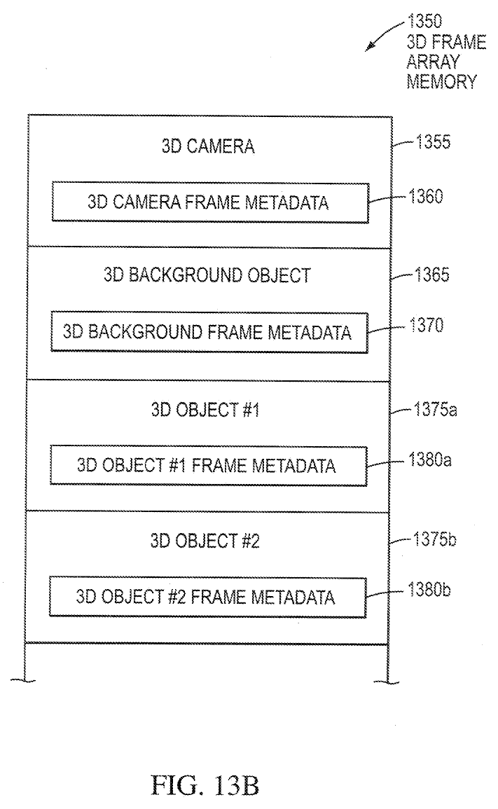

The segment analysis module 335 includes hardware, software and/or firmware that determines relevant element in the segment, (e.g., objects, actions, object importance, etc.). Generally, the segment analysis module 335 uses the dictionaries/libraries 325 and cinematic conventions to analyze a segment of interest in the text to determine relevant elements in the segment. The segment analysis module 335 may review adjacent and/or other segments to maintain cinematic consistency between storyboard frames. The segment analysis module 335 populates field to link the objects identified with specific graphical renderings. The segment analysis module 335 stores the relevant frame elements for each segment in a frame array memory 340. The details of the segment analysis module are 335 described with reference to FIG. 4. An example frame array memory 340 for a single storyboard frame is shown in and described below with reference to FIG. 13.

The cinematic frame arrangement module 345 includes hardware, software and/or firmware that uses cinematic conventions to arrange the frame objects associated with the segment and/or segments of interest. The cinematic frame arrangement module 345 determines whether to generate a single storyboard frame for a single segment, multiple storyboard frames for a single segment, or a single storyboard frame for multiple segments. This determination may be based on information generated by the segment analysis module 335.

In one embodiment, the cinematic frame arrangement module 345 first determines the frame size selected by the user. Using cinematic conventions, the cinematic frame arrangement module 345 sizes, positions and/or layers the frame objects individually to the storyboard frame. Some example of cinematic conventions that the cinematic frame arrangement module 345 may employ include:
Strong characters appear on right side of screen making that section of the screen a strong focal point.
Use rule of thirds; don't center a character.
Close-ups involve viewers emotionally.
Foreground elements are more dominant than environment elements.
Natural and positive movement is perceived as being from left to right.
Movement catches the eye.
Text in a scene pulls the eye toward it.
Balance headroom, ground space, third lines, horizon lines, frame edging, etc.

The cinematic frame arrangement module 345 places the background environment into the chosen frame aspect. The cinematic frame arrangement module 345 positions and sizes the background environment into the frame based on its significance to the other frame objects and to the cinematic scene or collection of shots with the same or similar environment image. The cinematic frame arrangement module 345 may place and size the background environment to fill the frame or so that only a portion of the background environment is visible. The cinematic frame arrangement module 345 may use an establishing shot rendering from the set of graphical renderings for the environment. According to one convention, if the text continues for several lines and no characters are mentioned, the environment may be determined to be an establishing shot. The cinematic frame arrangement module 345 may select the angle, distance, level of detail, etc. based on keywords noted in the text, based on environments of adjacent frames, and/or based on other factors.

The cinematic frame arrangement module 345 may determine character placement based on data indicating who is talking to whom, who is listening, the number of characters in the shot, information from the adjacent segments, how many frame objects are in frame, etc. The cinematic frame arrangement module 345 may assign an importance value to each character and/or object in the storyboard frame. For example, unless otherwise indicated by the text, a speaking character is typically given prominence. Each object may be placed into the storyboard frame according to its importance to the segment.

The cinematic frame arrangement module 345 may set the stageline between characters in the storyboard based on the first shot of an action sequence with characters. A stageline is an imaginary line between characters in the shot. Typically, the camera view stays on one side of the stageline, unless specific cinematic conventions are used to cross the line. Maintaining a consistent stageline helps to alleviate a “jump cut” between shots. A jump cut is when a character appears to “jump” or “pop” across a stageline in successive shots. Preserving the stageline from storyboard frame to storyboard frame is done by keeping track of the characters positions and the sides of the storyboard frame they are on. The number of primary characters in each shot (primary being determined by amount of dialog, frequency of dialog, frequency referenced by text in scene) assists in determining placement of the characters or props. If only one character is in a storyboard frame, then the character may be positioned on one side of the frame and may face forward. If more than one person is in storyboard frame, then the characters may be positioned to face towards the center of the storyboard frame or towards other characters along the stageline. Characters on the left typically face right; characters on the right typically face left. For three or more characters, the characters may be adjusted (e.g., sized smaller) and arranged to positions between the two primary characters. The facing of characters may be varied in several cinematic appropriate ways according to frame aspect ratio, intimacy of content, style, etc. The edges of the storyboard frame may be used to calculate object position, layering, rotating and sizing of objects into the storyboard frame. The characters maybe sized using the top frame edge and given specific zoom reduction to allow for specified headroom for the appropriate frame aspect ratio.

Several other cinematic conventions can be employed. The cinematic frame arrangement module 345 may resolve editorial conflicts by inserting a cutaway or close-up shot. The cinematic frame arrangement module 345 may review data about the previous shot to preserve continuity in much the same way as an editor arranges and juxtaposes shots for narrative cinematic projects. The cinematic frame arrangement module 345 may position objects and arrows appropriately to indicate movement of characters or elements in the storyboard frame or to indicate camera movement. The cinematic frame arrangement module 345 may layer elements, position elements, zoom into elements, move elements through time, add lip sync movement to characters, etc. according to their importance in the sequence structure. The cinematic frame arrangement module 345 may adjust the environment to the right or left to simulate a change in view across the stageline between storyboard frames, matching the characters variation of shot sizes. The cinematic frame arrangement module 345 may accomplish environment adjustments by zooming and moving the environment image.

The cinematic frame arrangement module 345 may select from various shot-types. For example, the cinematic frame arrangement module 345 may create an over-the-shoulder shot-type. When it is determined that two or more characters are having a dialogue in a scene, the cinematic frame arrangement module 345 may call for an over-the-shoulder sequence. The cinematic frame arrangement module 345 may use an over-the-shoulder shot for the first speaker and the reverse-angle over-the-shoulder shot for the second speaker in the scene. As dialogue continues, the cinematic frame arrangement module 345 may repeat these shots until the scene calls for close-ups or new characters enter the scene.

The cinematic frame arrangement module 345 may select a close-up shot type based on camera instructions (if reading text from a screenplay), the length and intensity of the dialogue, etc. The cinematic frame arrangement module 345 may determine dialogue to be intense based on keywords in parentheticals (actor instructions within text in a screenplay), punctuations in the text, length of dialogue scenes, the number of words exchanged in a lengthy scene, etc.

In one embodiment, the cinematic frame arrangement module 345 may attach accompanying sound (speech, effects and music) to one or more of the storyboard frames.

The playback module 350 includes hardware, software and/or firmware that enables playback of the cinematic shots. In one embodiment, the playback module 350 may employ in-frame motion and pan/zoom intra-frame or inter-frame movement. The playback module 350 may convert the text to a sound file (e.g., using text to speech), which it can use to dictate the length of time that the frame (or a set of frames) will be displayed during runtime playback.

FIG. 4 is a block diagram illustrating details of the segment analysis module 335, in accordance with an embodiment of the present invention. Segment analysis module 335 includes a character analysis module 405, a slug line analysis module 410, an action analysis module 415, a key object analysis module 420, an environment analysis module 425, a caption analysis module 430 and/or other modules (not shown).

The character analysis module 405 review each segment of text for characters in the frame. The character analysis module 405 uses a character name dictionary to search the segment of text for possible character names. The character name dictionary may include conventional names and/or customized by the user. The character analysis module 405 may use a generic character identifier dictionary to search the segment of text for possible generic character identifiers, e.g., “Lady #1,” “Boy #2,” “policeman,” etc. The segment analysis module 335 may use a generic object for rendering an object currently unassigned. For example, if the object is “policeman #1,” then the segment analysis module 335 may select a first generic graphical rendering of a policeman to be associated with policeman #1.

The character analysis module 405 may review past and/or future segments of text to determine if other characters, possibly not participating in this segment, appear to be in this storyboard frame. The character analysis module 405 may look for keywords, scene changes, parentheticals, slug lines, etc. that indicate whether a character is still in, has always been in, or is no longer in the scene. In one embodiment, unless the character analysis module 405 determines that a character from a previous frame has left before this segment, the character analysis module 405 may assume that those characters are still in the frame. Similarly, the character analysis module 405 may determine that a character in a future segment that never entered the frame must have always been there.

Upon detecting a new character, the character analysis module 405 may select one of the graphical renderings in the library 325 to associate with the new character. The selected character may be a generic character of the same gender, approximate age, approximate ethnicity, etc. If customized, the association may already exist. The character analysis module 405 stores the characters (whether by name, by generic character identifiers, by link etc.) in the frame array memory 340.

The slug line analysis module 410 reviews the segment of text for slug lines. For example, the slug line analysis module 410 looks for specific keywords, such as “INT” for interior or “EXT” for exterior as evidence that a slug line follows. Upon identifying a slug line, the slug line analysis module 410 uses a slug line dictionary to search the text for environment, time or other scene information. The slug line analysis module 410 may use a heuristic approach, removing one word at a time from the slug line to attempt to recognize keywords and/or phrases, e.g., fragments, in the slug line dictionary. Upon recognizing a word or phrase, the slug line analysis module 410 associates the detected environment or scene object with the frame and stores the slug line information in the frame array memory 340.

The action analysis module 415 review the segment of text for action events. For example, the action analysis module 415 uses an action dictionary to search for action words, e.g., keywords such as verbs, sounds, cues, parentheticals, etc. Upon detection an action event, the action analysis module 415 attempts to link the action to a character and/or object, e.g., by determining the subject character performing the action or object the action is being performed upon. In one embodiment, if the text indicates “Bob sits on the chair,” then the action analysis module 415 learns that an action of sitting is occurring, that Bob is the probable performer of the action, and that the location is on the chair. The action analysis module 415 may use a heuristic approach, removing one word at a time from the segment of text to attempt to recognize keywords and/or phrases, e.g., fragments, in the action dictionary. The action analysis module 415 stores the action information and possible character/object associations in the frame array memory 340.

The key analysis module 420 searches the segment of text for key objects, e.g., props, in the frame. In one embodiment, the key object analysis module 420 uses a key object dictionary to search for key objects in the segment of text. For example, if the text segment indicates that “Bob sits on the chair,” then the key object analysis module 420 determines that a key object exists, namely, a chair. Then, the key object analysis module 420 attempts to associate that key object with its position, action, etc. In this example, the key object analysis module 420 determines that the chair is currently being sat upon by Bob. The key object analysis module 420 may use heuristic approach, removing one word at a time from the segment of text to attempt to recognize keywords and/or phrases, e.g., fragments, in the key objects dictionary. The key object analysis module 420 stores the key object information and/or the associations with the character and/or object in the frame array memory 340.

The environment analysis module 425 searches the segment of text for environment information, assuming that the environment has not been determined by, for example, the slug line analysis module 410. The environment analysis module 425 may review slug line information determined by the slug line analysis module 410, action information determined by the action analysis module 415, key object information determined by the key object analysis module 420, and may use an environment dictionary to perform independent searches for environment information. The environment analysis module 410 may use a heuristic approach, removing one word at a time from the segment of text to attempt to recognize keywords and/or phrases, e.g., fragments, in the environment dictionary. The environment analysis module 420 stores the environment information in the frame array memory 340.

The caption analysis module 420 searches the segment of text for caption information. For example, the caption analysis module 430 may identify each of the characters, each of the key objects, each of the actions, and/or the environment information to generate the caption information. For example, if Bob and Sue are having a conversation about baseball in a dentist's office, in which Bob is doing most of the talking, then the caption analysis module 430 may generate a caption such as “While at the dentist office, Bob tells Sue his thoughts on baseball.” The caption may include the entire segment of text, a portion of the segment of text, or multiple segments of text. The caption analysis module 430 stores the caption information in the frame array memory 340.

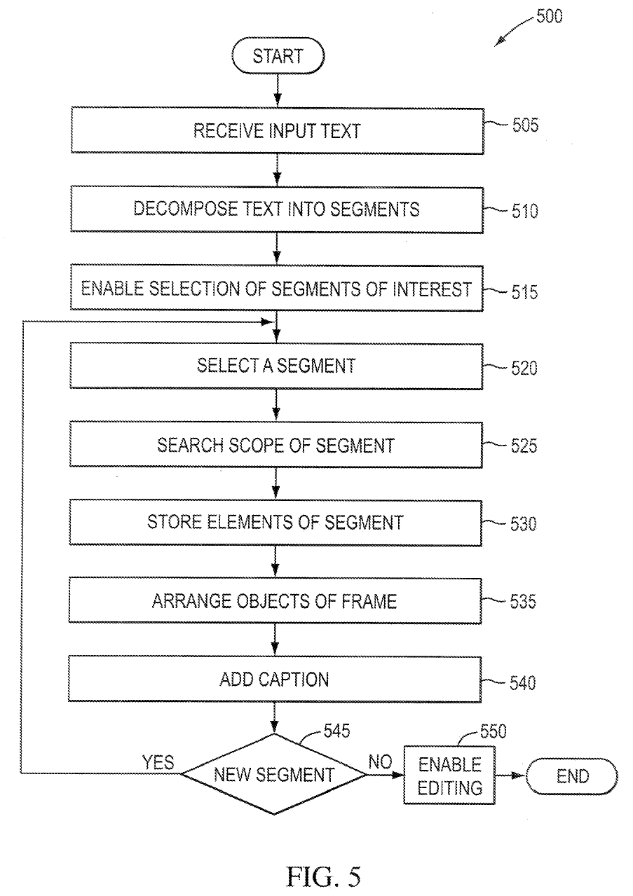

FIG. 5 is a flowchart illustrating a method 500 of converting text to cinematic images, in accordance with an embodiment of the present invention. The method 500 begins in step 505 by the input device 110 receiving input natural language text. In step 510, the text decomposition module 315 decomposes the text into segments. The segments of interest selection module 320 in step 515 enables the user to select a set of segments of interest for storyboard frame creation. The segments of interest selection module 320 may display the results to the user, and ask the user for start and stop scene numbers. In one embodiment, the user may be given a range of numbers (from x to n: the number of scenes found during the first analysis of the text) and location names if available. The user may enter the range numbers of interest for the scenes he or she wants to create storyboard frames and/or shots.

The segment analysis module 335 in step 520 selects a segment of interest for analysis and in step 525 searches the selected segment for elements (e.g., objects, actions, importance, etc.). the segment analysis module 335 in step 530 stores the noted elements in frame array memory 340. The cinematic frame arrangement module 345 in step 535 arranges the objects according to cinematic conventions, e.g., proxemics, into the frame and in step 540 adds the caption. The cinematic frame arrangement module 345 makes adjustments to each frame to create the appropriate cinematic compositions of the shot-types and shot combinations: sizing of the characters (e.g., full shot, close-up, medium shot, etc.); rotation and poses of the characters or objects (e.g., character facing forward, facing right or left, showing a character's back or front, etc.); placement, space between the elements based on proxemic patterns and cinematic compositional conventions; making and implementing decisions about stageline positions and other cinematic placement that the text may indicate overly or though searching and cinematic analysis of the text; etc. In step 545, the segment analysis module 335 determines if there is another segment for review. If so, then method 500 returns to step 520. Otherwise, the user interface 305 enables editing, e.g., substitutions locally/globally, modifications to the graphical renderings, modification the captions, etc. The user interface 305 may enable the user to continue with more segments of interest or to redo the frame creation process. Method 500 then ends.

Looking to the script 700 of FIG. 7 as an example, the input device 110 receiving script text 700 as input. The text decomposition module 315 decomposes the text 700 into segments. The segments of interest selection module 320 enables the user to select a set of segments of interest for frame creation, e.g., the entire script text 700. The segment analysis module 335 selects the first segment (the slug line) for analysis and searches the selected segment for elements (e.g., objects, actions, importance, etc.). The segment analysis module 335 recognizes the slug line keywords suggesting a new scene, and possibly recognizes the keywords of “NYC” and “daytime.” The segment analysis module 335 selects an environment image from the library 325 (e.g., an image of the NYC skyline or a generic image of a city) and stores the link in the frame array memory 340. Noting that the element is environment information from a slug line, the cinematic frame arrangement module 345 may select an establishing shot of NYC skyline during daytime or of the generic image of the city during daytime into the storyboard frame and may add the caption “NYC.” The segment analysis module 335 determines that there is another segment for review. Method 500 returns to step 520 to analyze the first scene description 710.

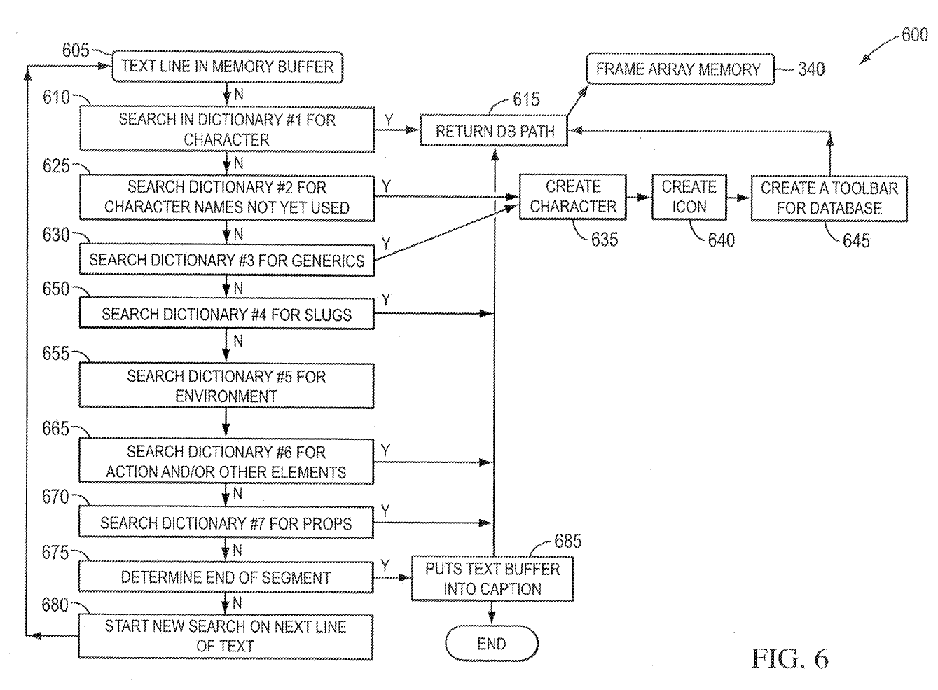

FIG. 6 is a flowchart illustrating details of a method 600 of analyzing text and generating frame array memory 340, in accordance with an embodiment of the present invention. The method 600 begins in step 605 wit the text buffer module 310 selecting a line of text, e.g., from a text buffer memory. In this embodiment, the line of text may be an entire segment or a portion of a segment. The segment analysis module 335 in step 610 uses a Dictionary #1 to determine if the line of text includes an existing character name. If a name is matched, then the segment analysis module 335 in step 615 returns the link to the graphical rendering in the library 325 and in step 620 stores the link into the frame array memory 340. If the line of text includes text other than the existing character name, the segment analysis module 335 in step 625 uses a Dictionary #2 to search the line of text for new character names. If the text line is determined to include a new character name, the segment analysis module 335 in step 635 creates a new character in the existing character Dictionary #1. The segment analysis module 335 may find a master character or a generic, unused character to associate with the name. The segment analysis module 335 in step 640 creates a character icon and in step 645 creates toolbar for the library 325. Method 600 then returns to step 615 to select and store the link in the frame array memory 340.

In step 630, if the line of text includes text other than existing and new character names, the segment analysis module 335 uses Dictionary #3 to search for generic character identifiers, e.g., gender information, to identify other possible characters. If a match is found, the method 600 jumps to step 635 to create another character to the known character Dictionary #1.

In step 650, if additional text still exists, the segment analysis module 335 uses Dictionary #4 to search the line of text for slug lines. If a match is found, the method 600 jumps to step 615 to select and store the link in the frame array memory 340. To search the slug line, the segment analysis module 335 may remove a word from the line and may search the Dictionary #4 for fragments. If determined to include a slug line but no match is found, the segment analysis module 335 may select a default environment image. If a slug line is identified and an environment is selected, the method 600 jumps to step 615 to select and store the link in the frame array memory 340.

In step 655, if additional text still exists, the segment analysis module 335 uses Dictionary #5 to search the line of text for environment information. If a match is found, the method 600 jumps to step 615 to select and store the link to the environment in the frame array memory 340. To search the line, the segment analysis module 335 may remove a word from the line and may search the Dictionary #5 for fragments. If no slug line was found and no match to an environment was found, the segment analysis module 335 may select a default environment image. If an environment is selected, the method 600 jumps to step 615 to select and store the link in the frame array memory 340.

In step 665, the segment analysis module 335 uses Dictionary #6 to search the line of text for actions, transitions, off screen parentheticals, sounds, music cues, and other story relevant elements that may influence cinematic image placement. To search the line for actions or other elements, the segment analysis module 335 may remove a word from the line and may search Dictionary #6 for fragments. For each match found, method 600 jumps to step 615 to select and store the link in the frame array memory 340. Further, for each match found, additional metadata may be associated with each object (e.g., environment, character, prop, etc.), the additional metadata usable for defining object prominence, positions, scale, etc.

The segment analysis module 335 in step 670 uses Dictionary #7 to search the line of text for key objects, e.g., props, or other non-character objects known to one skilled in the cinematic industry. For every match found, the method 600 jumps to step 615 to select and store the link in the frame array memory 340.

After the segment is thoroughly analyzed, the segment analysis module 335 in step 675 determines if the line of text is the end of a segment. If it is determined not to be the end of the segment, the segment analysis module 335 returns to step 605 to begin analyzing the next line of text in the segment. If it is determined that it is the end of the segment, the segment module 335 in step 680 puts an optional caption, e.g., the text, into a caption area for that frame. Method 600 then ends.

Looking to the script text 700 in FIG. 7 as an example, the first line (the first slug line 705) is selected in step 605. No existing characters are located in step 610. No new characters are located in step 625. No generic character identifiers are located in step 630. The line of text is noted to include a slug line in step 650. The slug line is analyzed and determined in slug line dictionary to include the term “ESTABLISH” indicating an establishing shot and to include “NYC” and “DAYTIME.” A link to an establishing shot of NYC during daytime in the library 325 is added to the frame array memory 340. Since a slug line identified environment information and/or no additional text remains, no environment analysis need by completed in step 655. No actions are located or no action analysis need be conducted (since no additional text exists) in step 665. No props are located or no prop analysis need be conducted (since no additional text exists) in step 670. The line of text is determined to be the end of the segment in step 675. A caption “NYC-Daytime” is added to the frame array memory 340. Method 600 then ends.

Repeating the method 600 for the next segment of script text 700 of FIG. 7 as another example, the first scene description 710 is selected in step 605. No existing characters are located in step 610. No new characters are located in step 625. No generic character identifiers are located in step 620. No slug line is located in step 650. Environment information is located in step 655. Matches may be found to keywords or phrases such as “cold,” “winter,” “day,” “street,” etc. The segment analysis module 335 may select an image of a cold winter day on the street from the library 325 and stores the link in the frame array memory 340. No actions are located in step 665. No props are located in step 670. The line of text is determined to be the end of the segment in step 675. The entire line of text may be added as a caption for this frame to the frame array memory 340. Method 600 then ends.

In one embodiment, the system matches the natural language text to the keywords in the dictionaries 325, instead of the keywords in the dictionaries to the natural language text. The libraries 325 may include multiple databases of assets, including still images, motion picture clips, 3D models, etc. The dictionaries 325 may directly reference these assets. Each storyboard frame may use an image as the environment layer. Each storyboard frame can contain multiple images of other assets, including images of arrows to indicate movement. The assets may be sized, rotated and positioned within a storyboard frame to appropriate cinematic compositions. The series of storyboard frames may follow proper cinematic, narrative structure in terms of shot composition and editing, to convey meaning though time, and as may be indicated by the story. Cinematic compositions may be employed including long shot, medium shot, two-shot, over-the-shoulder shot, close-up shot, extreme close-up shot, etc. Frame composition may be selected to influence audience reaction, and may communicate meaning and emotion about the character within the storyboard frame. The system 145 may recognize and determine the spatial relationship of the image objects within a storyboard frame and the relationship of the frame-to-frame juxtaposition. The spatial relationship may be related to the cinematic frame composition and the frame-to-frame juxtaposition. The system 145 may enable the user to move, re-size, rotate, edit, and layer the objects within the storyboard frame, to edit the order of the storyboard frames, and to allow for insertion and deletion of additional storyboard frames. The system 145 may enable the user to substitute an object and make a global change over the series of storyboard frames contained in the project. The objects may be stored by name, size and position in each storyboard frame, thus allowing a substituted object to appropriate the size and placement of the original object. The system 145 may enable printing the storyboard frames on paper. The system 145 may include the text associated with the storyboard frame to be printed if so desired by the user. The system 145 may enable outputting the storyboard frame to a single image file that maintains the layered characteristics of the objects within the shot or frame. The system 145 may associate sound with the storyboard frame, and may include a text-to-speech engine to create the sound track to the digital motion picture. The system 145 may include independent motion of objects within the storyboard frame. The system 145 may include movement of characters to lip sync the text-to-speech sounds. The sound track to an individual storyboard frame may determine the time length of the individual storyboard frame within the context of the digital motion picture. The digital motion picture may be made up of clips. Each individual clip may be a digital motion picture file that contains the soundtrack and composite image that the storyboard frame or shot represents, and a data file containing information about the objects of the clip. The system 145 may enable digital motion picture output to be imported into a digital video-editing program, wherein the digital motion picture may be further edited in accordance with film industry standards. The digital motion picture may convey a story and emotion representative of a narrative, motion picture film or video.

By extrapolating proxemic patterns, spatial relationships and other visual instructions, a 3D scene may be created that incorporates the same general content and positions of objects as a 2D storyboard frame. The 2D-to-3D frame conversion may include interpreting a temporal element of the beginning and the ending of a shot, as well as the action of objects and camera angle/movement. In the storyboard and animation industry, a 3D scene refers to a 3D scene layout, wherein 3D geometry provided as input is established in what is known as 3D space. 3D scene setup involves arranging virtual objects, lights, cameras and other entities (characters, props, location, background and/or the like) in 3D space. A 3D scene typically presents depth to the human eye to illustrate three-dimensionality or may be used to generate an animation.

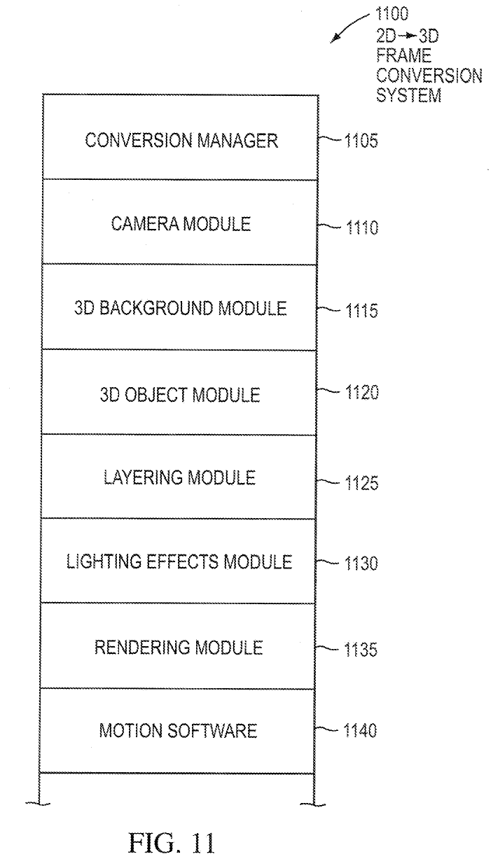

FIG. 11 is a block diagram illustrating details of a 2D-to-3D frame conversion system 1100, in accordance with an embodiment of the present invention. In one embodiment, the 2-D-to-3D frame conversion system 1100 includes hardware, software and/or firmware to enable conversion of a 2D storyboard frame into a 3D scene. In another embodiment, 2D-to-3D frame conversion system 1100 is part of the cinematic frame creation system 145 of FIG. 3.

In one embodiment, the 2D-to-3D frame conversion system 1100 operates in coordination with dictionaries/libraries 1200 (see FIG. 12), which may include a portion of all of the dictionaries/libraries 325. The dictionaries/libraries 1200 includes various 2D and 3D object databases and associated metadata enabling the rendering of 2D and 3D objects. As shown, the dictionaries/libraries 1200 includes 2D background objects 1200 with associated 2D background metadata 1210. The 2D background objects 1205 may include hand-drawn or real-life images of backgrounds from different angles, with different amount of detail, with various amount of depth, at various times of the day, at various times of the year, and/or the like. It will be appreciated that the same 2D background objects 1205 may be used for 2D storyboards and 3D scenes. That is, in one embodiment, a background in a 3D scene could be made up of either one or more of each of the following: a 3D object, or a 2D background object mapped onto a 3D image plane (e.g., an image plane of a sky with a 3D model of a mountain range in front of it or another image plane with a mountain range photo mapped onto it). This may depend on metadata associated with the 2D storyboard frame contained in the 2D frame array memory (see FIG. 13). The 2D background metadata 1210 may include attributes of each of the background objects 1205, e.g., perspective information (e.g., defining the directionality of the camera, the horizon line, etc.); common size factor (e.g., defining scale); rotation (e.g., defining image directionality); lens angle (e.g., defining picture format, focal length, distortion, etc.); image location (e.g., the URL or link to the image); name (e.g., “NYC skyline”); actions (e.g., defining an action which appears in the environment, an action which can be performed in the environment, etc.); relationship with other objects 1205 (e.g., defining groupings of the same general environment); and related keywords (e.g., “city,” “metropolis,” “urban area,” “New York,” “Harlem,” etc.).

The dictionaries/libraries 1200 further includes 2D objects 1215, including 2D character objects 1220 (and associated 2D character metadata 1225) and 2D prop objects 1230 (and associated 2D prop metadata 1235). The 2D character objects 1220 may include animated or real-life images of characters from different angles, with different amounts of detail, in various positions, from various distances, at various times of the day, wearing various outfits, with various expressions, and/or the like. The 2D character metadata 1225 may include attributes of each of the 2D character objects 1220, e.g., perspective information (e.g., defining the directionality of the camera to the character); common size factor (e.g., defining scale); rotation (e.g., defining character rotation); lens angle (e.g., defining picture format, focal length, distortion, etc.); 2D image location (e.g., the URL or link to the 2D image); name (e.g., “2D male policeman”); actions (e.g., defining the action which the character appears to be performing, the action which appears being performed on the character, etc.); relationship with other objects 1200 (e.g., defining groupings of images of the same general character); related keywords (e.g., “policeman,” “cops,” “detective,” “arrest,” “uniformed officer,” etc.); 3D object or object group location (e.g., a URL or link to the associated 3D object or object group). It will be appreciated that the general term “object” may also refer to the specific objects of a “background object,” a “camera object,” etc.

The 2D props 1230 may include animated or real-life images of props from different angles, with different amounts of detail, from various distances, at various times of the day, and/or the like. The 2D prop metadata 1235 may include attributes of each of the 2D prop objects 1230, e.g., perspective information (e.g., defining the directionality of the camera to the prop); common size factor (e.g., defining scale); rotation (e.g., defining prop rotation); lens angle (e.g., defining picture format, focal length, distortion, etc.); image location (e.g., the URL or link to the image); name (e.g., “2D baseball bat”); actions (e.g., defining the action which the prop appears to be performing or is capable of performing, the action which appears being performed on the prop or is capable of being performed on the prop, etc.); relationship to other prop objects 1230 (e.g., defining groupings of the same general prop); and related keywords (e.g., “baseball,” “bat,” “Black Betsy,” etc.).

The dictionaries/libraries 1200 further includes 3D objects 1240, including 3D character objects 1245 (and associated metadata 1260) and 3D prop objects 1265 (and associated metadata 1270). The 3D character objects 1245 may include animated or real-life 3D images of characters from different angles, with different amount of detail, in various positions, from various distances, at various times of the day, wearing various outfits, with various expressions, and/or the like. Specifically, as shown and as is well known in the art, the 3D character objects 1245 may include 3D character models 1250 (e.g., defining 3D image rigs) and 3D character skins 1255 (defining the skin to be placed on the rigs). It will be appreciated that a rig (e.g., defining the joints, joint dependencies, and joint rules) may enable motion, as is well known in the art. The 3D character metadata 1260 may include attributes of each of the 3D character objects 1245 including perspective information (e.g., defining the directionality of the camera to the 3D character); common size factor (e.g., defining scale); rotation (e.g., defining character rotation); lens angle (e.g., defining picture format, focal length, distortion, etc.); image location (e.g., the URL or link to the image); name (e.g., “3D male policeman”); actions (e.g., defining the action which the character appears to be performing or is capable of performing, the action which appears being performed on the character or is capable of being performed on the character, etc.); relationship to other prop objects 1230 (e.g., defining groupings of the same general character); and related keywords (e.g., “policeman,” “cop,” “detective,” “arrest,” “uniformed officer,” etc.).

The 3D prop objects 1265 may include animated or real-life 3D images of props from different angles, with different amounts of detail, from various distances, at various times of the day, and/or the like. The 3D prop metadata 1235 may include attributes of each of the 3D prop objects 1230, e.g. perspective information (e.g., defining the directionality of the camera to the prop); common size factor (e.g., defining scale); rotation (e.g., defining prop rotation); lens angle (e.g., defining picture format, focal length, distortion, etc.); image location (e.g., the URL or link to the image); name (e.g., “3D baseball bat”); actions (e.g., defining the action which the prop appears to be performing or is capable of performing the action which appears being performed on the prop or is capable of being performed on the prop, etc.); relationship to other prop objects 1230 (e.g., defining related groups of the same general prop); and related keywords (e.g., “baseball,” “bat,” “Black Betsy,” etc.).

It will be appreciated that the 2D objects 1215 may be generated from 3D objects 1240. For example, the 2D objects 1215 may include 2D snapshots of the 3D objects 1240 rotated on its y-axis plus or minus 0 degrees, plus or minus 20 degrees, plus or minus 70 degrees, plus or minus 150 degrees, and plus or minus 180 degrees. Further, to generate overhead view and upward-angle views, the 2D objects 1215 may include snapshots of the 3D objects 1240 rotated in same manner on the y-axis, but also rotated along the x-axis plus or minus 30-50 degrees and 90 degrees.

In one embodiment, the 2D-to-3D frame conversion system 1100 also operates with the 2D frame array memory 1300, which may include a portion or all of the frame array memory 340. The 2D frame array memory 130 stores the 2D background object 1305 (including the 2D background object frame-specific metadata 1310) and, in this example, two 2D objects 1315a and 1315b (each including 2D object frame-specific metadata 1320a and 1320b, respectively) for a particular 2D storyboard frame. Each 2D object 1315a and 1315b in the 2D storyboard frame may be generally referred to as a 2D object 1315. Each 2D object frame-specific metadata 1320a and 1320b may be generally referred to as 2D object frame-specific metadata 1320.

The 2D background frame-specific metadata 1310 may include attributes of the 2D background object 1305, such as cropping (defining the visible region the background image), lighting, positioning, etc. The 2D background frame-specific metadata 1310 may also include or identify the general background metadata 1210, as stored in the dictionaries/libraries 1200 for the particular background object 1205. The 2D object frame-specific metadata 1320 may include frame-specific attributes of each 2D object 1315 in the 2D storyboard frame. The 2D object frame-specific metadata 1320 may also include or identify the 2D object metadata 1225/1235, as stored in the dictionaries/libraries 1200 for the particular 2D object 1215. The 2D background frame-specific metadata 1310 and 2D object frame-specific metadata 1320 may have been generated dynamically during the 2D frame generation process from text as described above. Whether for a background object 1305 or a 3D object 1315, frame-specific attributes may includes object position (e.g., defining the position of the object in a frame), object scale (e.g., defining adjustments to conventional sizing—such as an adult-sized baby, etc.) object color (e.g., specific colors of object or object elements), etc.

In one embodiment, the 2D-to-3D frame conversion system 1100 includes a conversion manager 1105, a camera module 1110, a 3D background module 1115, a 3D object module 1120, a layering module 1125, a lighting effects module 1130, a rendering module 1135, and motion software 1140. Each of these modules 1105-1140 may intercommunicate to effect the 2D-to-3D frame conversion system 1100 generates the various 3D objects and stores them in a 3D frame array memory 1350 (see FIG. 13B). FIG. 13B illustrates an example 3D frame array memory 1350, storing a 3D camera object 1355 (including 3D camera frame-specific metadata 1360), a 3D background object 1365 (including 3D background frame-specific metadata 1370), and two 3D objects 1375a and 1375b (including 3D object frame-specific metadata 1380a and 1380b, respectively). Each 3D object 1375a and 1375b in the 3D scene may be generally referred to as a 3D object 1375. Each 3D object frame-specific metadata 1380a and 1380b may be generally referred to as 3D object frame-specific metadata 1380.

The conversion manager 1105 includes hardware, software and/or firmware for enabling selection of 2D storyboard frames for conversion to 3D scenes, initiation of the conversion process, selection of conversion preferences (such as skin selection, animation preferences, lip sync preferences, etc.), inter-module communication, module initiation, etc.

The camera module 1110 includes hardware, software and/or firmware for enabling virtual camera creation and positioning. In one embodiment, the camera module 1110 examines background metadata 1310 of the 2D background object 1305 of the 2D storyboard frame. As stated above, the background metadata 1310 may include perspective information, common size factor, rotation, lens angle, actions, etc., which can be used to assist with determining camera attributes. Camera attributes may include position, direction, aspect ratio, depth of field, lens size and other standard camera attributes. In one embodiment, the camera module 1110 assumes a 40-degree frame angle. The camera module 1110 stores the camera object 1355 and 3D camera frame-specific metadata 1360 in the 3D frame array memory 1350. It will be appreciated that the camera attributes effectively define the perspective view of the background object 1365 and 3D objects 1375, and thus may be important for scaling, rotating, positioning, etc. The 3D objects 1375 on the background object 1365.

In one embodiment, the camera module 1110 infers camera position by examining the frame edge of the 2D background object 1305 and the position of recognizable 2D objects 1315 within the frame edge of the 2D storyboard frame. The camera module 1110 calculates camera position in the 3D scene using the 2D object metadata 1320 and translation of the 2D frame rectangle to the 3D camera site pyramid. Specifically, to position the camera in the 3D storyboard scene, the visible region of the 2D background object 1305 is used as the sizing element. The coordinates of the visible area of the 2D background object 1305 are used to position the 3D background object 1365. That is, the bottom left corner of the frame is place at (0, 0, 0) in the 3D (x, y, z) world. The top left corner is placed at 0, E1 height, 0. The top right corner is placed at E1 width, E1 height, 0. The bottom right corner is placed at E1 width, 0, 0. A 2D background object 1305 may be mapped onto a 3D plane in 3D space. If the 2D background object 1305 has perspective metadata, then the camera module 1110 may position the camera object 1355 in 3D space based on the perspective metadata. For example, the camera module 1110 may base the camera height (or y-axis position) on the perspective horizon line in the background image. In some embodiments, the horizon line may be outside the bounds of the image. The camera module 1110 may base camera angle on the z-axis distance that the camera is placed from the background image.

Assuming perspective y value of ½ height of background image, and perspective x value of ½ width of background image, and an initial angle of the camera object 1355 at a normal lens of a 40-degree angle, then the camera module 1110 may position the camera object 1355 as: x=perspective x, y=perspective y, z=perspective x/tangent of ½ lens angle. The camera module 1110 may position the camera view angle so the view angle intersects the background image to show the frame as illustrated in the 2D storyboard frame. In one embodiment, the center of the view angle intersects the center of the background image.

The 3D background module 1115 includes hardware, software and/or firmware for converting a 2background object 1305 into a 3D background object 1365. In one embodiment, the same background object 1205 may be used in both the 2D storyboard frame and the 3D scene. In one embodiment, the 3D background module 1115 creates a 3D image plane and maps the 2D background object 1305 (e.g., a digital file of a 2D image, still photograph, or 2D motion/video file) onto the 3D image plane. The 3D background object 1365 may be modified by adjusting the visible background, by adjusting scale or rotation (e.g., to facilitate 3D object placement), by incorporating lighting effects such as shadowing, etc. In one embodiment, the 3D background module 1115 uses the 2D background metadata 1310 to crop the 3D background object 1365 so that the visible region of the 3D background object 1365 is the same as the visible region of the 2D background object 1305. In one embodiment, the 3D background module 1115 converts a 2D background object 1305 into two or more possible overlapping background objects (e.g., a mountain range in the distance, a city skyline in front of the mountain range, and a lake in front of the city skyline). The 3D background module 1115 stores the 3D background object(s) 1365 and 3D frame-specific background metadata 1370 in the 3D frame array memory 1350.

In some embodiments, the 3D background module 1115 maps a 2D object 1215 such as a 2D character object 1220, a 2D prop object 1230 or other object onto the 3D image plane. In such case, the 2D object 1215 acts as the 2D background object 1205. For example, if the 2D object 1215 in the scene is large enough to obscure (or take up) the entire area around the other objects in the frame or if the camera is placed high enough, then the 2D object 1215 may become the background image.

The 3D object module 1120 include hardware, software and/or firmware for converting a 2D object 1315 into 3D object 1375 for the 3D storyboard scene. In one embodiment, the frame array memory 1300 stores all 2D objects 1315 in the 2D storyboard frame, and stores or identifies 2D object frame-specific metadata 1320 (which includes or identifies general 2D object metadata (e.g., 2D character metadata 1225, 2D prop metadata 1235, etc.)). For each 2D object 1315, the 3D object module 1120 uses the 2D object metadata 1320 to select an associated 3D object 1240 (e.g., 3D character object 1245, 3D prop object 1265, etc.) from the dictionaries/libraries 1200. Also, the 3D object module 1120 uses the 2D object metadata 1320 and camera position information to position, scale, rotate, etc. The 3D object 1240 into the 3D scene. In one embodiment, to position the 3D object 1240 in the 3D scene, the 3D object module 1120 attempts to block the same portion of the 2D background object 1305 as is blocked in the 2D storyboard frame. In one embodiment, the 3D object module 1120 modifies the 3D objects 1240 in the 3D scene by adjusting object position, scale or rotation (e.g., to facilitate object placement, to avoid object collisions, etc.), by incorporating lighting effects such as shadowing, etc. In one embodiment, each 3D object 1240 is placed on its own plane and is initially positioned so that no collisions occur between 3D objects 1240. The 3D object module 1120 may coordinate with the layering module 1125 discussed below to assist with the determination of layers for each of the 3D objects 1240. The 3D objects 1240 (including 3D object frame-specific metadata determined) are stored in the 3D frame array memory 1350 as 3D objects 1375 (including 3D object frame-specific metadata 1380).

It will be appreciated that imported or user-contributed objects and/or models may be scaled to a standard reference where the relative size may fit within the parameters of the environment to allow 3D coordinates to be extrapolated. Further, a model of a doll may be distinguished from a model of a full-size human by associated object metadata or by scaling down the model of the doll on its initial import into the 2D storyboard frame. The application may query user for size, perspective and other data on input.

The layering module 1125 includes hardware, software and/or firmware for layering the 3D camera object 1355, 3D background objects 1365, and 3D objects 1375 in accordance with object dominance, object position, camera position, etc. In one embodiment, the layering module 1125 uses the frame-specific metadata 1360/1370/1380 to determine the layer of each 3D object 1355/1365/1375. The layering module 1125 stores the layering information in the 3D frame array memory 1350 as additional 3D object frame-specific metadata 1360/1370/1380. Generally, layer 1 typically contains the background object 1355. The next layers, namely, layers 2-N, typically contain the characters, props and other 3D objects 1375. The last layer, namely, layer N+1, contains the camera object 1355. As expected, a 3D object 1375 in layer 2 appears closer to the camera object 1355 than the 3D object 1375 on layer 1. It will be appreciated that 2D objects 1375 may contain alpha channels where appropriate to allow viewing through layers.

The center of each 2D and 3D object 1305/1240 may be used to calculate offsets in both 2D and 3D space. The metadata 1310/1260/1270 matrixed with the offsets and the scale factors may be used to calculate and translate objects between 2D and 3D space. The center of each 2D object 1315 offset from the bottom left corner may be used to calculate the x-axis and y-axis position of the 3D object 1375. The scale factor in the 2D storyboard frame may be used to calculate the position of the 3D object 1375 on the z-axis in 3D space. For example, assuming all 3D objects 1375 after the background object 1365 have the same common size factor and layer 2 is twice the scale of layer 1 in 2D space, then layer 2 will be placed along the z-axis at a distance between the camera object 1355 and the background object 1365 relative to the inverse square of the scale, in this case, four (4) times closer to the camera object 1355. The 3D object module 1120 may compensate for collision by calculating the 3D sizes of the 3D object 1375 and then computing the minimum z-axis distance needed. The z-axis position of the camera may be calculated so that all 3D objects 1375 fit in the representative 3D storyboard scene.

The lighting effects module 1130 includes hardware, software and/or firmware for creating lighting effects in the 3D storyboard scene. In one embodiment, the lighting effects module 1130 generates shadowing and other lightness/darkness effects based on camera object 1355 position, light source position, 3D object 1375 position, 3D object 1375 size, time of day, refraction, reflectance, etc. In one embodiment, the lighting effects module 1130 stores the lighting effects as an object (not shown) in the 3D frame array memory 1350. In another embodiment, the lighting effects module 1130 operates in coordination with the rendering module 1135 and motion software 1140 (discussed below) to generate dynamically the lighting effects based on the camera object 1355 position, light source position, 3D object 1375 position, 3D object 1375 size, time of day, etc. In another embodiment, the lighting effects module 1130 is part of the rendering module 1135 and/or motion software 1140.

The rendering module 1135 includes hardware, software and/or firmware for rendering a 3D scene using the 3D camera object 1355, 3D background object 1365 and 3D objects 1375 stored in the 3D frame array memory 1350. In one embodiment, the rendering module 1135 generates 3D object 1375 renderings from object models and calculates rendering effects in a video editing file to produce final object rendering. The rendering module 1135 may use algorithms such as rasterization, ray casting, ray tracing, radiosity and/or the like. Some example rendering effects may include shading (how color and brightness of a surface varies with lighting), texture-mapping (applying detail to surfaces), bump-mapping (simulating small-scale bumpiness on surfaces), fogging/participating medium (how light dims when passing through non-clear atmosphere or air), shadowing (the effect of obstructing light), soft shadows (varying darkness caused by partially obscured light sources), reflection (mirror-like or highly glossy reflection), transparency (sharp transmission of light through solid objects), translucency (high scattered transmission of light through solid objects), refraction (bending of light associated with transparency), indirect illumination (illumination by light reflected off other surfaces), caustics (reflection of light off a shiny object or focusing of light through a transparent object to produce bright highlights on another object), depth of field (blurring objects in front or behind an object in focus), motion blur (blurring objects due to high-speed object motion or camera motion), photorealistic morphing (modifying 3D renderings to appear more life-like), non-photorealistic rendering (rendering scenes in an artistic style, intending them to look like a painting or drawing), etc. The rendering module 1135 may also use conventional mapping algorithms to map a particular image to an object model, e.g., a famous personalities likeness to a 3D character model.

The motion software 1140 includes hardware, software and/or firmware for generating a 3D scene. In one embodiment, the motion software 1140 request a 3D scene start-frame, a 3D scene end-frame, 3D scene intermediate frames, etc. In one embodiment, the motion software 1140 employs conventional rigging algorithms, e.g., including animating and skinning. Rigging is the process of preparing an object for animation. Boning is a part of the rigging process that involves the development of an internal skeleton affecting where an object's joints are and how they move. Constraining is a part of the rigging process that involves the development of rotational limits for the bones and the addition of controller objects to make object manipulation easier. Using the conversion manager and motion software 1140, a user may select a type of animation (e.g., walking for a character model, driving for a car model, etc.). The appropriate animation and animation key frames will be applied to the 3D object 1375 in the 3D storyboard scene.

It will be appreciated that the 3D storyboard scene process may be an interative process. That is, for example, since 2D object 1315 manipulation may be less complicated and faster than 3D object 1375 manipulation, a user may interact with the user interface 305 to select and/or modify 2objects 1315 and 2D object metadata 1320 in the 2D storyboard frame. Then, a 3D scene may be re-generated from the modified 2D storyboard frame.

It will be further appreciated that the 2-to-3D frame conversion system 1100 may enable “cheating a shot.” Effectively, the camera's view is treated as the master frame, and all 3D objects 1375 are placed in 3D space to achieve the master frame's view without regard to real-world relationships or semantics. For example, the conversion system 1100 need not “ground” (or “zero out”) each of the 3D objects 1375 in a 3D scene. For example, a character may be positioned such that the character's feet wold be buried below or floating above ground. So long as the camera view or layering renders the cheat invisible, the fact that the character's position renders his or her feet in an unlikely place is effectively moot. It will be further appreciated that the 2D-to-3D frame conversion system 1100 may also cheat the “close-ups” by zooming in on a 3D object 1375.

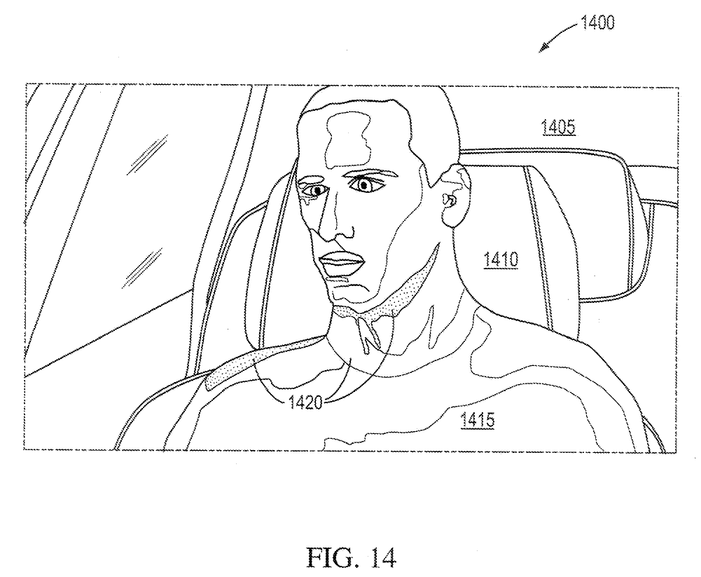

FIG. 14 illustrates an example 2D storyboard 1400, in accordance with an embodiment of the present invention. The 2D storyboard 1400 includes a car interior background object 1405, a 2D car seat object 1410, a 2D adult male object 1415, and lighting effects 1420.

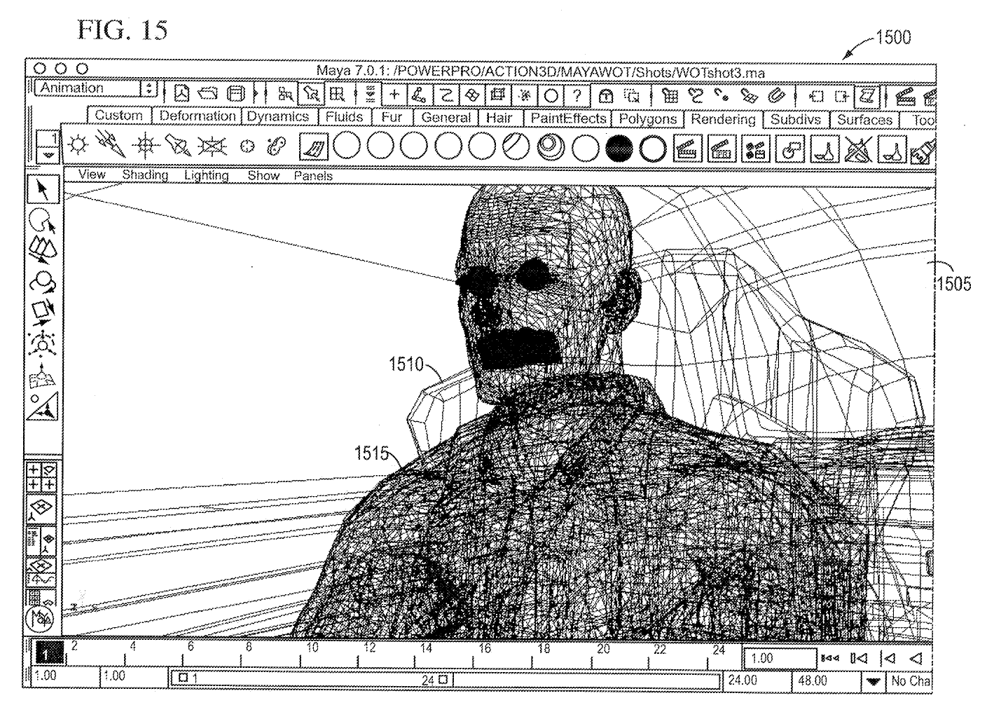

FIG. 15 illustrates an example 3D wireframe 1500 generated from the 2D storyboard 1400, in accordance with an embodiment of the present invention. The 3D wireframe 1500 includes a car interior background object 1505, a 3D car seat object 1510, and a 3D adult male object 1515.

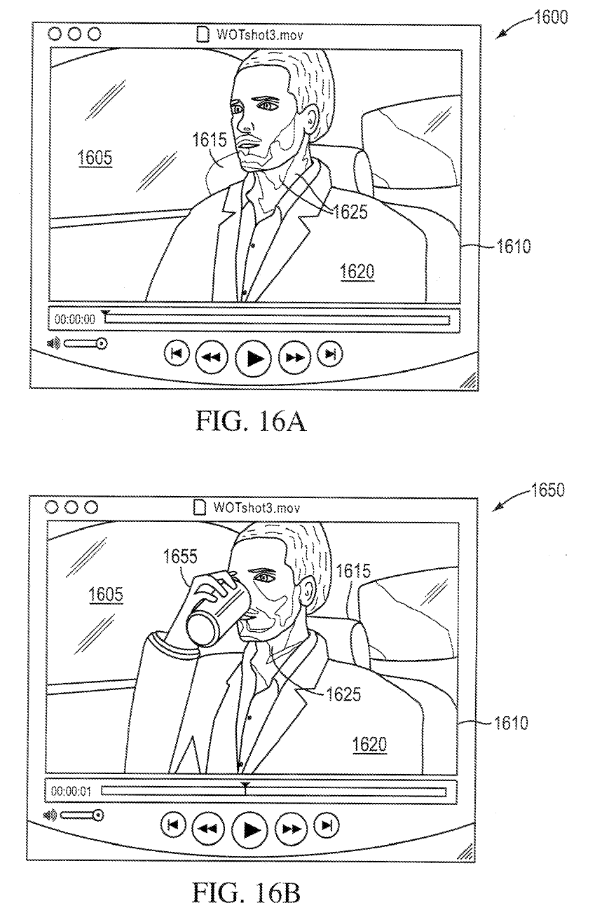

FIG. 16A illustrates an example 3D storyboard scene 1600 generated from the 3D wireframe 1500 and 2D frame array memory 1300 for the 2D storyboard 1400, in accordance with an embodiment of the present invention. The 3D storyboard scene 1600 includes a cityscape background image plane 1605, a car interior object 1610, a 3D car seal object 1615, a 3D adult male object 1620, and lighting effects 1625. The 3D storyboard scene 1600 may be used as a keyframe, e.g., a start frame, of an animation sequence. In animation, keyframes are the drawings essential to define movement. A sequence of keyframes defines which movement the spectator will see. The position of the keyframes defines the timing of the movement. Because only two or three keyframes over the span of a second do not create the illusion of movement, the remaining frames are filled with more drawings called “inbetweens” or “tweening.” With keyframing, instead of having to fix an object's position, rotation, or scaling for each frame in an animation, one need only setup some keyframes between which states in every frame may be interpolated.

FIG. 16B illustrates an example 3D storyboard scene 1650 that may be used as an end-frame of an animation sequence, in accordance with an embodiment of the present invention. Like FIG. 16A, the 3D storyboard scene 1650 includes a cityscape background image plane 1605, a car interior object 1610, a 3D car seat object 1615, a 3D adult male object 1620, and lighting effects 1625. FIG. 16B also includes the character's right arm, hand and a soda can in his hand 1655, each naturally positioned in the 3D scene such that the character is drinking from the soda can. Using 3D animation software, intermediate 3D storyboard scenes may be generated, so that upon display of the sequence of 3D storyboard scenes starting from the start frame of FIG. 16A via the intermediate frames ending with the end frame of FIG. 16B, the character appears to lift his right arm from below the viewable region to drink from the soda can.

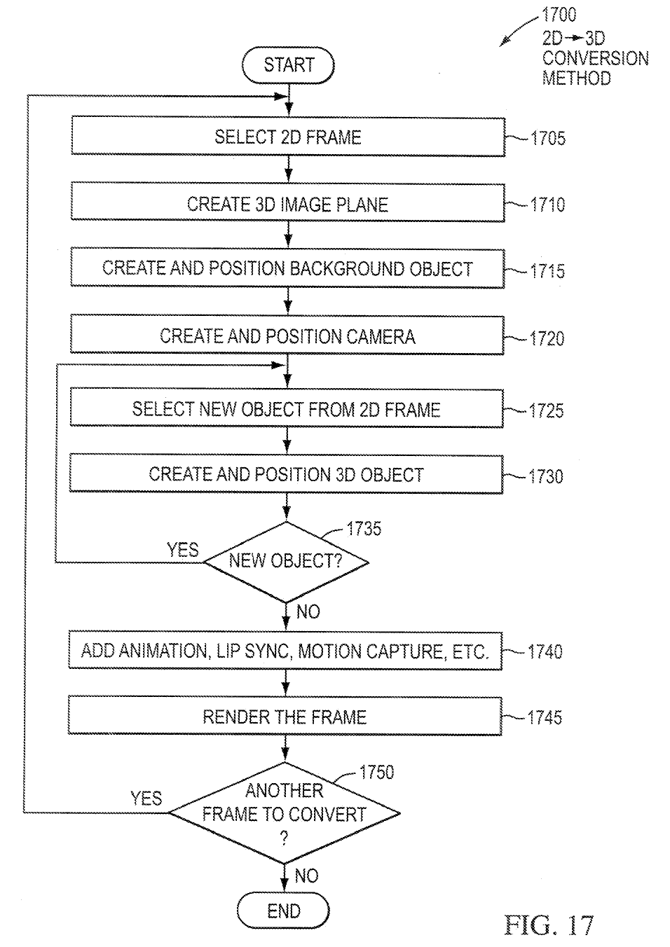

FIG. 17 is a flowchart illustrating a method 1700 of converting a 2D storyboard frame to a 3D storyboard scene, in accordance with an embodiment of the present invention. Method 1700 begins with the conversion manager 1105 in step 1705 selecting a 2D storyboard frame for conversion. The 3D background module 1115 in step 1710 creates a 3D image plane to which the 2D background object 1305 will be mapped. The 3D background module 1115 in step 1710 may use background object frame-specific metadata 1310 to determine the image plane's position and size. The 3D background module 1115 in step 1715 creates and maps the 2D background object 1305 onto the image plane to generate the 3D background object 1355. The camera module 1110 in step 1720 creates and positions the camera object 1305, possibly using background object frame-specific metadata 1310 to determine camera position, lens angle, etc. The 3D object module 1120 in step 1725 selects a 2D object 1315 from the selected 2D storyboard frame, and in step 1730 creates and positions a 3D object 1375 into the storyboard scene, possibly based on the 2D object metadata 1320 (e.g., 2D character metadata 1225, 2D prop data 1235, etc.). To create the 3D object 1375, the 3D object module 1120 may select a 3D object 1240 that is related to the 2D object 1315, and scale and rotate the 3D object 1240 based on the 2D object metadata 1320. The 3D object module 1120 may apply other cinematic conventions and proxemic patterns (e.g., to maintain scale, to avoid collisions, etc.) to size and position the 3D object 1240. Step 1730 may include coordinating with the layering module 1125 to determine layers for each of the 3D objects 1375. The 3D object module 1120 in step 1735 determines if there is another 2D object 1315 to convert. If so, then the method 1700 returns to step 1725 to select the new 2D object 1315 for conversion. Otherwise, the motion software 1140 in step 1740 adds animation, lip sync, motion capture, etc., to the 3D storyboard scene. Then, the rendering module 1135 in step 1745 renders the 3D storyboard scene, which may include coordinating with the lighting effects module 1130 to generate shadowing and/or other lighting effects. The conversion manager 1105 in step 1750 determines if there is another 2D storyboard frame to convert. If so, then the method 1700 returns to step 1705 to select a new 2D storyboard frame for conversion. Method 1700 then ends.

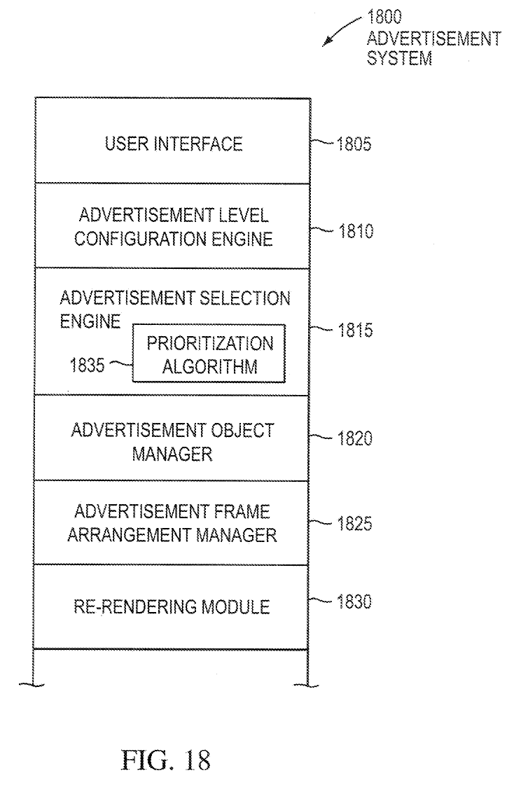

FIG. 18 is a block diagram illustrating an advertisement system 1800, which may be a part of the cinematic frame creation system 145, in accordance with an embodiment of the present invention. The advertisement system 1800 includes a user interface 1805, an advertisement level configuration engine 1810, an advertisement selection engine 1815 implementing a prioritization algorithm 1835, an advertisement object manager 1820, an advertisement frame arrangement manager 1825, and a re-rendering module 1830.

The user interface 1805 includes hardware, software and/or firmware that enables a user to interact with the advertisement system 1800. Via the user interface 1805, the user may communicate with the various components of the advertisement system 1800, e.g., to select an advertisement level, to select particular advertisements for inclusion in a storyboard frame and/or 3D scene, to order/group the advertisements based on predetermined and/or selectable criteria, to instruct the system 1800 to automatically select advertisements based on the priority algorithm 1835, to modify the priority algorithm 1835, etc.

The advertisement level configuration engine 1810 includes hardware, software and/or firmware that enables the user to select a level of advertisements. In one embodiment, the advertisement level configuration engine 1810 enables the user to select from a predetermined list of level indicators, e.g., a number between 0 (no advertisements) and 10 (many advertisements), or none (e.g., 0 advertisements), low (e.g., 1-2 advertisements), medium (e.g., 3-4 advertisements), high (e.g., 5-10 advertisements) and silly (e.g., 11-100 advertisements). In one embodiment, the level indicator determines the number of advertisements in a storyboard frame and/or scene based on the number of objects in the storyboard frame and/or scene. For example, a “high” number of advertisements may be lower in a storyboard frame with a lesser number of objects and higher in a storyboard frame with a greater number of objects. Alternatively, a “high” number of advertisements may be higher in a storyboard frame with a lesser number of objects and lower in storyboard frame with a greater number of objects. Other variables and definitions may also be possible.

The advertisement selection engine 1815 includes hardware, software and/or firmware that enables the user to select advertisements for inclusion into a storyboard frame and/or scene, and/or enables automatic selection of advertisements. In one embodiment, the advertisement selection engine 1815 presents the list of all available advertisements to the user. In another embodiment, the advertisement selection engine 1815 groups the advertisements, possibly based on advertisement attributes, e.g., advertisement type (e.g., replacement object, additional object, replacement text, additional text, cutaway scene, billboard, skin, character business, etc.), advertisement relevance (e.g., how relevant the advertisement is to the storyboard frame/scene content), advertisement appropriateness (e.g., how likely the advertisement type or advertisement content may be found in the environment {e.g., outdoors, indoors, car interior, etc.}, geographic location, content of the storyboard frame/scene, etc.), advertisement bid value, etc. From the list or groups, the advertisement selection engine 1815 may enable the user to select advertisements to include in a storyboard frame and/or scene.

In one embodiment, the advertisement selection engine 1815 applies the prioritization algorithm 1835 to prioritize and select advertisements for inclusion into the storyboard frame and/or scene. The prioritization algorithm 1835 may determine a priority value based on the various advertisement attributes, e.g., an advertisement relevance value, an advertisement appropriateness value, an advertisement bid value, an advertisement type value, and/or the like. For example, the prioritization algorithm 1835 may generate a weighted sum of the attribute values to generate the priority value of the advertisement. Then, based on the advertisement level indicator, the advertisement selection engine 1815 may select the top N number of advertisements. Or, the advertisement selection engine 1815 may present the priority-ordered list to the user for advertisement selection.

It will be appreciated that, if two characters at a breakfast table in a diner are discussing cola beverages, a relevant and appropriate advertisement may include replacing the dialogue to identify a particular brand of cola beverage. Accordingly, its relevance value and appropriateness value may be high. In the same scene, replacing a box of cereal on the breakfast table to a particular brand of cereal would be less relevant to the content, although appropriate. Accordingly, its relevance value may be low, and its appropriateness value may be high. In the same scene, placing a billboard advertisement in the diner would be less appropriate, although based on the content of the advertisement (e.g., advertising Pepsi® Cola) may be relevant. Accordingly, its appropriateness value may be low, and its relevance value may be high. Using a prioritization algorithm 1835 that weights appropriateness over relevance, the advertisement selection engine 1815 may prioritize replacing the dialogue as first, replacing the box of cereal as second, and adding a billboard advertising Pepsi® Cola as third.

In one embodiment, the advertisement selection engine 1815 may prioritize advertisement types in the following order:
1) Replacement 3D object—e.g., replacing existing object with advertisement object;
2) 3D object Skin—e.g., adding advertisement skin onto existing object;
3) New 3D object—e.g., adding new advertisement object;
4) Character business—e.g., adding “real-life” character action to existing character;
5) Billboard or object skin—e.g., adding a billboard with advertisement content, magazine cover, store front, signage, character image, etc. to existing or new objects or background;
6) Cutaway to existing object—e.g., camera movement to focus on existing object
7) Cutaway to new object—e.g., camera movement to focus on new advertisement object;
8) Dialogue change—e.g., text change from text to advertisement text; and
9) Dialogue addition—e.g., adding advertisement text.

In one embodiment, the advertisement selection engine 1815 may use an exclusion-based priority algorithm 1835 to select advertisements. That is, based on the frame content, advertisements may be deemed relevant or irrelevant, appropriate or not appropriate, etc. Before generating a priority value, the advertisement selection engine 1815 may exclude or devalue all inappropriate advertisements, may exclude or devalue irrelevant advertisements, may exclude or devalue all advertisements of improper type, and/or the like. Then, the advertisement selection engine 1815 may select or may enable the user to select the advertisements from the remainder.

In one embodiment, the advertisement selection engine 1815 may examine timing values and object constraints to determine whether particular advertising is possible. For example, based on timing constraints within character dialogue, the advertisement selection engine 1815 may determine whether a character has time to drink from a soda can. If so, then the advertisement may be selected. If there is insufficient time, either the advertisement selection engine 1815 may exclude the advertisement as unavailable or may modify the timing constraints to make room for the advertisement.

In one embodiment, the advertisement selection engine 1815 excludes all advertisements that cannot cooperate with the objects of the storyboard frame or scene. For example, if a character object is capable of drinking or smoking, but not capable of riding a bicycle, then all advertisements associated with riding a bicycle may be excluded.

The advertisement object manager 1820 includes hardware, software and/or firmware that modifies storyboard frames and/or scenes to add a selected advertisement For example, the advertisement object manager 1820 may add selected advertisement objects (e.g., props, backgrounds, characters, etc.) to a storyboard frame/scene, replace objects with advertisement objects within a storyboard frame/scene, may map advertisement skins (e.g., branding, clothing, signage content, etc.) onto prop and/or character objects within a storyboard frame/scene, etc. In one embodiment, the advertisement object manager 1820 modifies the 2D frame array memory 1300 and/or the 3D frame array memory 1350, e.g., adds and/or changes links to direct and/or redirect the 2D frame array memory 1300 and/or 3D frame array memory 1350 to the advertisement objects, etc. The advertisement object manager 1820 may determine the layers to place objects. If replacing an object or object skin, then the advertisement object manager 1820 may be configured not to modify the object metadata, thus not modifying its layer. However, when adding a new object into a storyboard frame/scene, the advertisement object manager 1820 may determine the layer based on a predetermined level of dominance, based on the object's relevance, based on appropriateness, based on bid value, and/or the like.

In one embodiment, each object in the dictionaries/libraries 1200 includes object metadata that specifies how it can be modified and/or used for advertisement and/or other object capabilities. For example, a 3D character model 1250 of a 3D character object 1245 may define certain character business that it is capable of doing. A 3D character skin 1255 of a 3D character object 1245 may define different clothing it can wear. The 3D prop metadata 1270 of a 3D prop object 1265 may define various skin types that can be mapped to it. The advertisement selection engine 1815 may use the object metadata to exclude advertisements that are accordingly unavailable.

The advertisement frame arrangement manager 1825 includes hardware, software and/or firmware that manipulates a storyboard scene, e.g., a 3D storyboard scene, to include cutaways (e.g., redirecting camera to a particular object), character business (e.g., things people do in real life such as eating, smoking, drinking, or like action, whether relevant or not, that typically does not take the attention away from the character's focus, action or dialogue), etc. For example, if two characters are driving in a car, then the advertisement frame arrangement manager 1825 may add character motion to cause the non-speaking character to drink from a can of a particular brand of soda. Or, if two characters are in the kitchen, then the advertisement frame arrangement manager 1825 may add a particular brand of cereal box on the counter and may add a cutaway to focus the camera on the cereal box. It will be appreciated that character business and/or cutaways may be implemented by modifying objects in the 2D frame array memory 1300 and/or in the 3D frame array memory 1350, and adding an intermediate shot (which will cause the motion software 1140 to effect the character business and/or cutaway). It will be appreciated that the advertisement object manager 1820 may be part of the advertisement frame arrangement manager 1825.

The re-rendering module 1830 includes hardware, software and/or firmware that re-renders a frame or scene, after the advertisement object manager 1820 and/or advertisement frame arrangement manager 1825 modifies the 2D frame array memory 1300 and/or 3D frame array memory 1350.

It will be appreciated that the advertisement system 1800 may select advertisements dynamically. That way, advertisements can be selected based on current bid status. For example, in certain embodiments, advertisers may have cap amounts that they can spend in a given period. Further, bid amounts may change. Accordingly, the system 1800 may be able to replace advertisements of previous highest bidders for advertisements of current highest bidders.

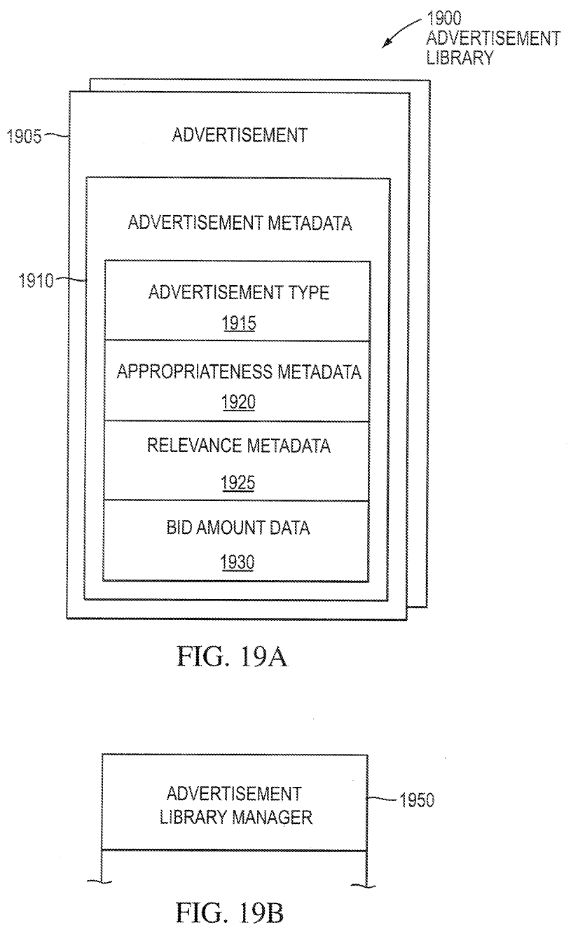

FIG. 19A is a block diagram illustrating an example advertisement library 1900, in accordance with an embodiment of the present invention. The advertisement library 1900 includes a set of advertisements 1905. Each advertisement 1905 may include an object (e.g., a Coke® can or character object), an advertisement skin (e.g., the skin to map onto a prop object or character object), advertisement text (e.g., to replace text or add to the text of a 3D frame and/or scene), a billboard object (which can be populated to advertise almost any item), advertisement character business, etc.

Each advertisement 1905 may include advertisement metadata 1910. The advertisement metadata 1910 may include advertisement type 1915 identifying an advertisement as an object, a skin, text, character business, etc. The advertisement metadata 1910 may include appropriate metadata 1920 that identifies particular situations, environments, backgrounds, locations, scene necessities, and/or the like to facilitate the determination and/or valuation whether the advertisement type 1915 and/or content of the advertisement 1905 is appropriate to the storyboard frame and/or scene. The appropriateness metadata 1920 may include a hierarchy of appropriateness data, for determining whether an associated advertisement 1905 would be more appropriate in certain situations than in other situations. The advertisement metadata 1910 may also include relevance metadata 1925 that identifies content that would facilitate the determination and/or valuation whether the associated advertisement 1905 is relevant to the storyboard frame and/or scene content. The relevance metadata 1925 may include a hierarchy of relevance, for determining whether the associated advertisement 1905 would be more relevant in certain situations than in other situations. The advertisement metadata 1910 may also include bid amount data 1930 that indicates how much an advertiser is offering to pay should the associated advertisement 1905 be presented in the storyboard frame and/or scene. The bid amount data 1930 may be dependent on the appropriateness value, relevance value, type value, etc. For example, an advertiser may pay more for character business, than for a billboard advertisement. Similarly, an advertiser may pay for appropriate character business in a related scene than for appropriate character business in an unrelated scene. The bid amount data 1930 may specify additional parameters, e.g., a maximum amount in a given month, a varying bid based on the number of times the item appears in a given frame and/or scene or in a particular time frame, etc. Various other possibilities exist.

In one embodiment, the advertisement metadata 1910 includes the advertiser ID, advertiser name, advertisement type, advertisement ID, maximum bid, minimum bid, minimum size, minimum time, expiration date, desired presentation times, etc.

FIG. 19B is a block diagram illustrating an advertisement library manager 1950, in accordance with an embodiment of the present invention. The advertisement library manager 1950 enables advertisers to input and/or modify advertisements 1905 and/or metadata 1910 in the advertisement library 1900. In one embodiment, the advertisement library manager 1950 is part of the cinematic frame creation system 145 on the server computer 225.

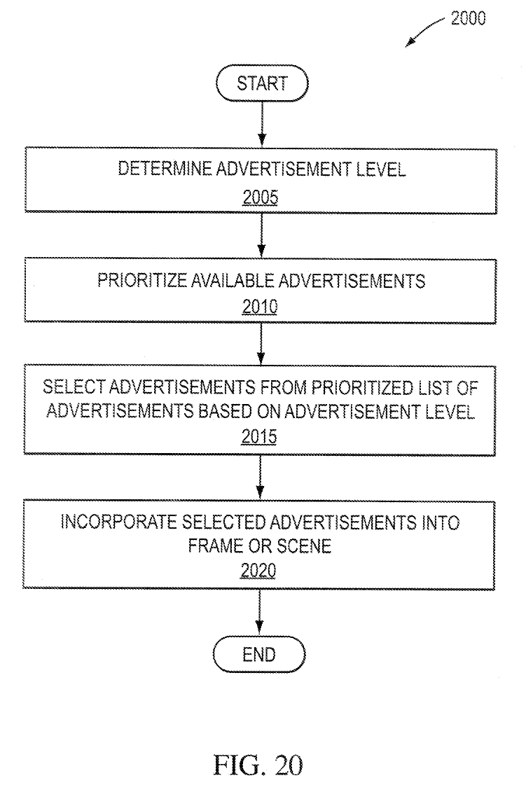

FIG. 20 is a flowchart illustrating a method 2000 of adding advertisement to a 3D frame and/or scene, in accordance with an embodiment of the present invention. Method 2000 begins with the advertisement level configuration engine 1810, possibly in coordination with the user interface 1805, in step 2005 determining advertisement level. The advertisement selection engine 1815, possibly using the prioritization algorithm 1835 and advertisement metadata 1910, in step 2010 prioritizes available advertisements 1905. The advertisement selection engine 1815, possibly in coordination with the user interface 1805, in step 2015 selects advertisements 1905 from the prioritized list of advertisements 1905. In one embodiment, the advertisement selection engine 1815 selects a number of advertisements based on the advertisement level determined in step 2005. The advertisement object manager 1820 and/or advertisement frame arrangement manager 1825 in step 2020 incorporates the selected advertisements 1905 into the storyboard frame and/or scene. Method 2000 then ends.

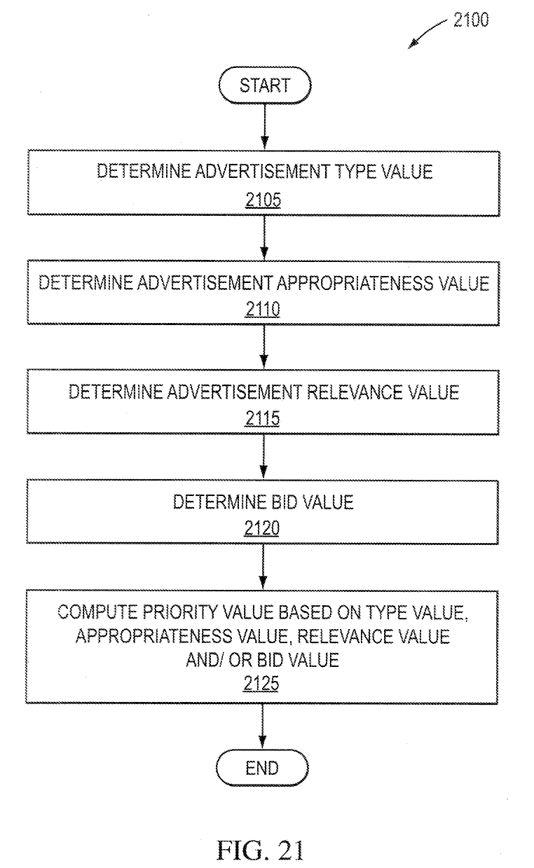

FIG. 21 is a flowchart illustrating a method 2100 of prioritizing available advertisements, as in step 2010 of FIG. 20, in accordance with an embodiment of the present invention. Method 2100 begins with the advertisement selection engine 1815, in coordination with the prioritization algorithm 1835, in step 2105 determining the advertisement type value. In one embodiment, the prioritization algorithm 1835 determines a type value of a particular type of advertisement 1905, regardless of scene content, based on scene content, based on characters being in the scene, etc. The advertisement selection engine 1815, in coordination with the prioritization algorithm 1835, in step 2110 determines the advertisement appropriateness value. In one embodiment, the advertisement selection engine 1815 determines an appropriateness value of an advertisement 1905 based on the advertisement type 1915 and/or advertisement content. The advertisement selection engine 1815, in coordination with the prioritization algorithm 1835, in step 2115 determines the advertisement relevance value of an advertisement 1905. In one embodiment, the advertisement selection engine 1815 determines a relevance value of an advertisement 1905 based on the appropriateness metadata 1920 and on the advertisement content relative to the storyboard frame and/or scene content. The advertisement selection engine 1815, in coordination with the prioritization algorithm 1835, in step 2120 determines the bid value of the advertisement 1905. In one embodiment, the advertisement selection engine 1815 determines the bid value based on the bid amount data 1930, the advertisement type 1915, the appropriateness value, the relevance value, the storyboard frame and/or scene content, and/or the like. The advertisement selection engine 1815, possibly in coordination with the prioritization algorithm 1835, in step 2125 computes the priority value based on the type value, the appropriateness value, the relevance value, the bid value, and/or other values. In one embodiment, the advertisement selection 1815 uses a weighted summation. Other algorithms for prioritizing advertisements 1905 are also possible. Method 2100 then ends.

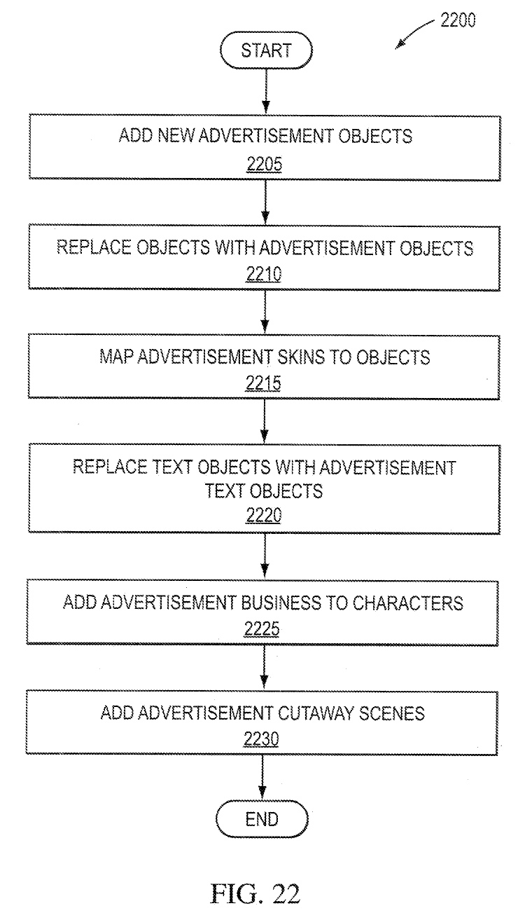

FIG. 22 is a flowchart illustrating a method 2200 of incorporating advertisements 1905 into a storyboard frame and/or scene, as in step 2020 of FIG. 20, in accordance with an embodiment of the present invention. Method 2200 begins with the advertisement object manager 1820 in step 2205 adding new advertisement objects (including object metadata) to the 3D frame array memory 1350 to add the new object into a storyboard frame and/or scene. In one embodiment, the advertisement object manager 1820 determines the object metadata to place the new advertisement object into the storyboard frame and/or scene at a particular location, at a particular layer, etc.

The advertisement object manager 1820 in step 2210 replaces original objects in a storyboard frame and/or scene with advertisement objects. For example, the advertisement object manager 1820 may replace a generic cola can with a brand name. In one embodiment, the advertisement object manager 1820 changes a link in 3D frame array memory 1350 from the original object to the advertisement object, and does not modify the object metadata in the 3D frame memory 1350 so that the object's position and layer remain the same.

The advertisement object manager 1820 in step 2215 maps skins to objects. In one embodiment, the advertisement object manager 1820 adds a link associated with the object in the 3D frame array memory 1350 to the skin.

The advertisement object manager 1820 in step 2220 replaces text with advertisement text. In one embodiment, the advertisement object manager 1820 replaces links to text objects with links to advertisement text objects. In another embodiment, the advertisement object manager 1820 modifies the text itself to replace the original text with the advertisement text.

The advertisement frame arrangement manager 1825 in step 2225 adds advertisement business to characters in the storyboard frame and/or scene. In one embodiment, the advertisement frame arrangement manager 1825 adds one or more intermediate frames into the 3D frame array memory 1350 to enable the character business.

The advertisement frame arrangement manager 1825 in step 2230 adds cutaway scenes into a scene. In one embodiment, the advertisement frame arrangement manager 1825 adds one or more intermediate frames into the 3D frame array memory 1350 to enable cutaway scenes.

Method 2200 then ends.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general-purpose digital computer, using application specific integrated circuits, or using a network of interconnected conventional components and circuits. Connections may be wired, wireless, modem, etc. The embodiments described herein are not intended to be exhaustive or limiting. The present invention is limited only the the following claims.

1. A system comprising:
a frame array memory for storing frames of a scene, each frame including a set of objects;
an advertisement library for storing advertisements;
an advertisement selection engine coupled to the advertisement library operative to enable selecting a number of the advertisements from the advertisement library; and
an advertisement manager coupled to the advertisement selection engine and to the frame array memory operative to incorporate selected advertisements into the scene.

2. The system of claim 1, wherein one of the advertisements includes one of a replacement object, a new object, a replacement skin for one of the set of objects, a new skin for a new object, replacement text, new text, a billboard, character business for a character object in the set of objects, a cutaway to one of the objects, or a cutaway to a new object.

3. The system of claim 1, wherein
each of the objects of the set of objects includes object metadata defining corresponding capabilities; and
the advertisement selection engine uses the object metadata to determine available advertisements.

4. The system of claim 1, wherein
each of the advertisements includes advertisement metadata, the advertisement metadata defining attributes of the advertisements, and
the advertisement selection engine uses a prioritization algorithm and the advertisement metadata to prioritize at least a portion of the advertisements.

5. The system of claim 4, wherein the advertisement selection engine generates a prioritized list of advertisements and enables a user to select the number of advertisements from the prioritized list of advertisements.

6. The system of claim 4, wherein the advertisement metadata includes bid amount data.

7. The system of claim 4, wherein the advertisement metadata includes relevance metadata.

8. The system of claim 4, wherein the advertisement metadata includes appropriateness metadata.

9. The system of claim 4, wherein the advertisement metadata includes advertisement type.

10. The system of claim 1, wherein the advertisement selection engine enables a user to select the number of advertisements.

11. The system of claim 1, further comprising an advertisement level configuration engine coupled to the advertisement selection engine operative to determine a level indicator for determining the number of advertisements.

12. The system of claim 1, further comprising an advertisement library manager coupled to the advertisement library operative to enable an advertiser to input the advertisements into the advertisement library.

13. The system of claim 1, wherein the advertisement manager incorporates the selected advertisements into one of the frames of the scene.

14. The system of claim 1, wherein the advertisement manager incorporates the selected advertisements into at least one new frame and adds the at least one new frame to the scene.

15. A method comprising:
storing frames of a scene, each frame including a set of objects;
storing advertisements and advertisement metadata;
enabling selection of a number of the advertisements; and
incorporating selected advertisements into the scene.

16. The method of claim 15, wherein one of the advertisements includes one of a replacement object, a new object, a replacement skin for one of the set of objects, a new skin for a new object, replacement text, new text, a billboard, character business for a character object in the set of objects, a cutaway to one of the objects, or a cutaway to a new object.

17. The method of claim 15,
wherein each of the objects of the set of objects includes object metadata defining corresponding capabilities; and
further comprising using the object metadata to determine available advertisements.

18. The method of claim 15,
wherein each of the advertisements includes advertisement metadata, the advertisement metadata defining attributes of the advertisements, and
further comprising using a prioritization algorithm and the advertisement metadata to prioritize at least a portion of the advertisements.

19. The method of claim 18, further comprising
generating a prioritized list of advertisements; and
enabling a user to select the number of advertisements from the prioritized list of advertisements.

20. The method of claim 18, wherein the advertisement metadata includes bid amount data.

21. The method of claim 18, wherein the advertisement metadata includes relevance metadata.

22. The method of claim 18, wherein the advertisement metadata includes appropriateness metadata.

23. The method of claim 18, wherein the advertisement metadata includes advertisement type.

24. The method of claim 15, further comprising enabling a user to select the number of advertisements.

25. The method of claim 15, further comprising establishing a level indicator for determining the number of advertisements.

26. The method of claim 15, further comprising enabling an advertiser to input advertisements.

27. The method of claim 15, wherein the step of incorporating includes incorporating the selected advertisements into one of the frames of the scene.

28. The method of claim 15, wherein the step of incorporating includes incorporating the selected advertisements into at least one new frame and adding the at least one new frame to the scene.
